(19) United States
(12) Patent Application Publication
(10) Pub. No.: US 2025/0389658 A1
(43) Pub. Date: Dec. 25, 2025

(54) SYSTEMS AND METHODS FOR IMAGING A SAMPLE

(71) Applicant: 10x Genomics, Inc., Pleasanton, CA (US)

(72) Inventors: Zhenping GUAN, Pleasanton, CA (US); David HOFFMAN, Pleasanton, CA (US); Denis PRISTINSKI, Dublin, CA (US)

(21) Appl. No.: 19/248,252

(22) Filed: Jun. 24, 2025

Related U.S. Application Data
(60) Provisional application No. 63/663,345, filed on Jun. 24, 2024.

(51) Int. Cl. G01N 21/64; G02B 27/14

(52) U.S. Cl. CPC G01N 21/645; G01N 21/6486; G02B 27/141; G01N 2021/6463

(57) ABSTRACT

An imaging system, comprising: a tube lens; a first image sensor; a second image sensor; an objective disposed to direct emission light from a focal plane of the objective to the tube lens. The first image sensor and the second image sensor are arranged at focal planes of the tube lens. A beamsplitter is disposed along a first optical axis between the tube lens and the first image sensor to intercept the path of the emission light. The beamsplitter comprises: an ingress face arranged perpendicular to the first optical axis, a transmission-reflection face arranged oblique to the ingress face and downstream of the ingress face along the first optical axis, wherein the transmission-reflection face is arrange to transmit a first component of the emission light along the first optical axis and reflect a second component of the emission light along a second optical axis, a first egress face arranged downstream of the transmission-reflectance face along the first optical axis, and a second egress face arranged downstream of the transmission reflectance face along the second optical axis. The first egress face is arranged perpendicular to the first optical axis, and the second egress face is arranged perpendicular to the second optical axis.

### CROSS-REFERENCE TO RELATED APPLICATIONS

This application claims the benefit of and priority to U.S. Provisional Application No. 63/663,345, filed Jun. 24, 2024, which is hereby assigned to the assignee hereof and herby expressly incorporated by reference in its entirety as if fully set forth below and for all applicable purposes.

### FIELD

The disclosure relates to imaging systems, and methods of imaging for samples (e.g. biological samples), and more particularly to systems and methods for imaging different wavelengths emitted from a sample using separate image sensors.

### BACKGROUND

In situ detection and analysis methods are emerging from the rapidly developing field of spatial transcriptomics. The key objectives in spatial transcriptomics are to detect, quantify, and map gene activity to specific regions in a tissue sample at cellular or sub-cellular resolution. These techniques allow one to study the subcellular distribution of gene activity (as evidenced, e.g., by expressed gene transcripts), and have the potential to provide crucial insights in the fields of developmental biology, oncology, immunology, histology, etc.

Fluorescence microscopes are widely used tools that illuminate fluorescently-tagged or stained targets within a sample to image those targets with the sample. In fluorescence microscopy, fluorophores are excited by excitation light having a fluorophore-dependent excitation spectrum and then emit a fluorescence emission light having a fluorophore-dependent emission spectrum. Images of the fluorescence can be detected by a camera. Fluorescence microscopes are particularly useful in biological fields because they allow researchers to collect high-resolution images without damaging sensitive samples.

Epifluorescence microscopy, in which both the excitation light and the emission light travels through the same light path (e.g., through the same objective lens), is one implementation of a microscope used for fluorescence imaging. Transillumination microscopy, in which the excitation light illuminates the sample from the opposite side of the objective lens, is another implementation of a microscope used for fluorescence imaging.

Some fluorescence microscopes are designed to detect emission light from multiple fluorophores at once. In these, each fluorophore respectively emits fluorescence emission light of a different fluorophore-dependent emission spectrum. However there are challenges in increasing the image throughput. For example, a typical fluorescence microscope has a single image sensor and images only one wavelength at a time. Accordingly, there exists a need for a fluorescence microscope with increased image throughput.

Many fluorescence microscopes include an infinity-corrected objective to collect the emission light. Infinity corrected objectives do not form an image themselves (or, in other words, are focused at infinity—i.e., at an infinite distance or very far distance that is effectively an infinite distance) and therefore transmit the light collected from the sample as parallel, collimated beams. This type of microscope further includes a tube lens downstream of the infinity corrected objective to focus the parallel, collimated beam to a focal point. The image sensors are positioned to capture an image of the sample at or near the focal plane of the tube lens (i.e. the image of the sample is focused onto the image sensor). Such optical circuits are commonly referred to as infinity-corrected systems, where the optical path between the objective and the tube lens is referred to as the infinity space. The focal plane of the objective and tube lenses can be described as field, focal or image-forming conjugate planes.

The infinity space provides a path of parallel light rays. Advantageously, optical components can be positioned in the infinity space without introducing aberration (e.g., spherical) or modifying the focal distance of the tube lens, making optical systems design more versatile. As such, peripheral functions of microscopes seek to make use of the infinity space. However, there are challenges in the placement and configuration of additional optical components in the microscope including in the use of the infinity space. For example, the infinity space is a limited resource and introducing additional optical components in the infinity space can increase the cost of the instrument as a whole (e.g., increase the size and cost of the required tube lens). Therefore, a need exists to reduce the number of optical components in the infinity space. There is also a need to form high quality images with minimal aberrations at the image sensors.

### SUMMARY

This summary is provided to introduce in simplified form a selection of concepts that are further described herein. The summary is not intended to identify key or essential features of the invention.

One or more aspects of an invention are set out in the claims.

There is provided an imaging system, comprising: a tube lens; a first image sensor; a second image sensor; and an objective disposed to direct emission light from a focal plane of the objective to the tube lens. The first image sensor and the second image sensor are arranged at focal planes of the tube lens. The imaging system also comprises a beamsplitter disposed along a first optical axis between the tube lens and the first image sensor to intercept the path of the emission light. The beamsplitter comprises: an ingress face arranged perpendicular to the first optical axis, a transmission-reflection face arranged oblique to the ingress face and downstream of the ingress face along the first optical axis. The transmission-reflection face is arranged to transmit a first component of the emission light along the first optical axis and reflect a second component of the emission light along a second optical axis. The beamsplitter further comprises: a first egress face arranged downstream of the transmission-reflectance face along the first optical axis, and a second egress face arranged downstream of the transmission reflectance face along the second optical axis. The first egress face is arranged perpendicular to the first optical axis, and/or the second egress face is arranged perpendicular to the second optical axis.

Optionally, the first egress face is parallel to the ingress face.

Optionally, the angle between the second egress face and the ingress face is equal to 180 degrees minus double the angle between the ingress face and the transmission-reflectance face, optionally wherein the transmission-reflection face is angled at 45 degrees with respect to the ingress face.

Optionally, the beamsplitter is a dichroic beamsplitter, optionally wherein the transmission-reflection face is a dichroic face.

Optionally, the beamsplitter includes a wavelength independent beamsplitting element and a colour filter associated with each of the first and second egress faces, optionally wherein the beamsplitting element is a 50-50 beamsplitter.

Optionally, the beamsplitter has a rectangular prism shape, optionally a cube shape.

Optionally, the beamsplitter comprises two triangular prisms.

Optionally, a face of one of the triangular prisms is mated to a face of the other and the transmission-reflection face comprises one or both of the mated faces.

Optionally, the tube lens is a single tube lens.

Optionally, the ingress face and first egress face are arranged so that astigmatism at the first image sensor is less than 0.075 RMS waves of the first component of emission light, and/or the ingress face and the second egress face are arranged so that astigmatism at the first image sensor is less than 0.075 RMS waves of the first component of emission light.

Optionally, the ingress face and first egress face are arranged so that an optical path difference in the beamsplitter between marginal tangential rays and marginal sagittal rays equidistant from the first optical axis is less than about 1 wavelength of the first component; and/or the ingress face and second egress face are arranged so that an optical path difference in the beamsplitter between marginal tangential rays and marginal sagittal rays equidistant from the second optical axis is less than about 1 wavelength of the second component.

Optionally, the objective comprises a numerical aperture (NA) of: at least 0.8, about 0.8 to about 1.2, or about 1.0.

Optionally, the objective has a field of view (FOV) of about 1.1 mm measured across a diagonal, and/or field curvature is within a 0.35 mm depth of field for each colour channel, and/or an axial chromatic shift through the beamsplitter is less than about 0.1 mm, and/or a lateral chromatic shift across the beamsplitter is within 4.0 μm.

Optionally, the ingress face is sized and positioned so that all rays of the emission light enter the beamsplitter through the ingress face.

Optionally, the transmission-reflection face is a first transmission-reflection face and the beamsplitter further comprises: a second transmission-reflection face arranged oblique to the ingress face and downstream of the ingress face along the first optical axis, wherein the second transmission-reflection face is arranged to transmit the first component of the emission light and reflect a third component of the emission light along a third optical axis; and a third egress face arranged downstream of the second transmission-reflection face along the third optical axis. The third egress face is arranged perpendicular to the third optical axis.

Optionally, the second transmission-reflection face intersects the first transmission-reflection face.

The imaging system optionally further comprises a sample, wherein, when first and second fluorophores of the sample are excited by illumination light, the first and second components of the emission light are emitted by the first and second fluorophores respectively.

There is also provided an imaging system, comprising: a tube lens; a first image sensor; a second image sensor; and an objective disposed to direct emission light from a focal plane of the objective to the tube lens. The first image sensor and the second image sensor are arranged at focal planes of the tube lens. The imaging system further comprises a beamsplitter disposed in an optical path between the tube lens and the first and second image sensor. The beamsplitter comprises: a first transmission channel arranged to transmit a first component of the emission light to the first image sensor, and a second transmission channel arranged to transmit a second component of the emission light to the second image sensor. The first transmission channel is arranged so that astigmatism in the emission light at the first image sensor is less than 0.075 RMS waves of the first component of emission light, and/or the second transmission channel is arranged so that astigmatism in the emission light at the second image sensor is less than 0.075 RMS waves of the second component of emission light.

Optionally, the first transmission channel is arranged so that an optical path difference in the beamsplitter between marginal tangential rays and marginal sagittal rays equidistant from an optical axis of the first transmission channel is less than about 1 wavelength of the first component, and/or the second transmission channel is arranged so that an optical path difference in the beamsplitter between marginal tangential rays and marginal sagittal rays equidistant from an optical axis of the second transmission channel is less than about 1 wavelength of the second component.

There is also provided a method for imaging a sample with the imaging system as described herein, the method comprising: capturing, by the first image sensor and the second image sensor, images of emission light emitted by a sample at the focal plane of the objective. An image captured by the first image sensor corresponds to the first component of the emission light and an image captured by the second image sensor corresponds to the second component of the emission light. Optionally, the method further comprises, prior to capturing the images of emission light, illuminating the sample with illumination light; and/or generating, by at least one processor, combined image data by combining the images captured by the first image sensor and the second image sensor.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. Following drawings are appended to facilitate the understanding of the invention. The drawings show embodiments, which will now be described by way of example only, where:

FIG. 1 depicts an overview of a volumetric sample imaging system and illustrates a Field of View (FOV) grid bounding the sample (e.g., hydrogel, tissue section, one or more cells, etc.) as projected onto the surface of a solid substrate supporting the sample.

FIG. 2 depicts the XZ cross-sectional view and illustrates tissue non-uniformity in the Z dimension, where the full (non-reduced) imaging volume is oversampled in the Z dimension. The objective lens focal point is positioned to acquire an image at every Z-slice in a Z-stack. An XZ image of signal distribution (bottom) demonstrates a non-uniform distribution of detected signal within the imaging volume.

FIG. 3 is an example workflow of analysis of a biological sample (e.g., a cell or tissue sample) using an opto-fluidic instrument, according to various embodiments.

FIGS. 4A-4B illustrate cross-sectional views of an optics module in an imaging system.

FIG. 5 depicts a computing node according to some embodiments disclosed herein.

FIG. 6 shows a dual camera imaging system for fluorescence microscopy, according to some embodiments.

FIG. 7 shows an imaging system for fluorescence microscopy, according to some embodiments.

FIG. 8 shows an imaging system suitable for use in fluorescence microscopy, according to some embodiments.

FIG. 9a shows an exemplary beamsplitter suitable for use in the imaging system of FIG. 8, according to some embodiments.

FIG. 9b shows another exemplary beamsplitter suitable for use in the imaging system of FIG. 8, according to some embodiments.

FIG. 9c shows yet another exemplary beamsplitter suitable for use in the imaging system of FIG. 8, according to some embodiments.

FIG. 10 shows a ray trace simulation view of a portion of the imaging system of FIG. 8, according to some embodiments.

FIG. 11 shows an exemplary method for imaging a sample, according to some embodiments.

In the figures, elements and steps having the same or similar reference numeral have the same or similar attributes or description, unless explicitly stated otherwise.

The patent or application file contains at least one drawing executed in color. Copies of this patent or patent application publication with color drawing(s) will be provided by the Office upon request and payment of the necessary fee.

### DETAILED DESCRIPTION

The following overview is provided to introduce in simplified form a selection of concepts that are further described herein. The overview is not intended to identify only key or essential features of the invention.

The present disclosure relates to an imaging system with an objective lens, a tube lens and a beamsplitter. The beamsplitter has at least three external faces and a transmission-reflection face. The beamsplitter is disposed in an optical path between the tube lens and at least a first and second image sensor (i.e., the beamsplitter is not disposed in the infinity space between the objective and the tube lens). The beamsplitter is arranged to guide emission light to the first and second image sensors. In some embodiments, the beamsplitter separates light of a first wavelength from light of a second wavelength, enabling light of the first wavelength to reach the first image sensor and light of the second wavelength to reach the second image sensor. In some embodiments, the beamsplitter separates light substantially equally between the first and second image sensors. The present disclosure contemplates a single tube lens and a beamsplitter (e.g., dichroic beamsplitter) disposed after the tube lens to reduce the number of optical components required and therefore reduce the overall cost of the imaging system. Were the beamsplitter to be disposed in the infinity space, two tube lenses would be required, one for each of the split beams. Because, tube lenses are relatively expensive optical components, positioning the beamsplitter after the tube lens allows for production of a lower cost imaging system that has substantially similar performance (e.g., aberration can be corrected to achieve substantially similar performance) as another, more-expensive imaging system having two tube lenses.

For imaging systems employing a beamsplitter in the infinity space, in some embodiments, the beamsplitter is a plate dichroic. Use of a plate dichroic in the infinity space may not adversely affect the image captured by the image sensors disposed in the focal conjugate plane (e.g., the plate dichroic imparts minimal aberration to reflected and transmitted rays). However, positioning a plate dichroic downstream of the tube lens does not have the same benefits. In particular, positioning a plate dichroic in the optical path after the tube lens causes aberration (e.g., astigmatism) to occur at the focal conjugate plane. This aberration is due to the angled plate creating a difference in optical path length for marginal rays at opposite sides of the beam (equidistant from the optical axis) in the tangential and/or meridional plane. A difference in angle of incidence on the ingress or entry face of the plate between rays at opposite sides of the beam (equidistant from the optical axis) for rays in the tangential plane causes a difference in angle of refraction into the plate and therefore a difference in optical path through the plate and hence a difference in optical path length from the ingress face to the egress (or exit) face of the plate. The difference in optical path length creates an asymmetrical phase delay across the beam in the tangential plane, which causes an astigmatism at the first image sensor. Rays in the sagittal plane are not affected in the same way as those in the tangential plane, because the angle of incidence of rays in this plane does not differ between opposite sides of the beam (equidistant from the optical axis). This difference in behaviour between marginal rays in the tangential plane and those in the sagittal plane creates a difference in position between the tangential and sagittal focal positions. Thus, the thickness and angle of the plate relative to the optical axis of the beam cause astigmatism for the beam wavelengths passing through the plate. This astigmatism (which can be modelled as the Z₂⁻² Zernike polynomial) can have an RMS value at the image sensor greater than the diffraction limit, thereby adversely affecting the quality of the image. The wavelengths reflected by the front face of the plate dichroic are not affected in the same way as the transmitted ones and thus the reflected beam directed to the second image sensor does not have the same aberration at the transmitted beam to the first image sensor.

A factor affecting the degree of astigmatism (e.g. the RMS error in the Zernike polynomial) introduced by the plate dichroic is cone half angle (CHA), which is defined as the angle between a marginal ray in the beam downstream of the tube lens and the optical axis of the beam. The larger the CHA, the larger the aberration caused by the plate dichroic at 45 degrees. If the CHA is zero (like in a pinhole camera), there will be minimal (e.g. near zero or zero) geometrical aberration. For this reason, plate dichroics are typically placed between the objective and the tube lens in the infinity space, where all the ray bundles are collimated (zero CHA). An ideal plate dichroic will not change the collimation of a ray bundle and therefore will not introduce aberration (although this assumption of an ideal plate dichroic may not hold in practice). The CHA downstream of the tube lens is fixed by the relationship between the numerical aperture (NA) and the system's magnification. The aberration introduced by a plate dichroic placed downstream of the tube lens may be correctable by deconvolution, for example, but this is computationally expensive. Thus, there exists a need to provide substantially similar optical path lengths for all rays that are incident on the beam splitter (e.g., dichroic) positioned after the tube lens.

Embodiments are directed to addressing these and other problems associated with beamsplitters in multi-image-sensor imaging systems.

In some embodiments, the beamsplitter is arranged so that astigmatism in a beam transmitted through the beamsplitter is reduced compared with use of a plate dichroic at the same location (i.e., in the optical path after the tube lens). The astigmatism at the first image sensor may be reduced to at or below the diffraction limit. To achieve this, ingress and egress faces of the beamsplitter are arranged so that the converging light from the tube lens enters and exits the beamsplitter with minimal phase delay across the beam. In particular, ingress and egress faces are arranged so that there is minimal or no phase difference between rays at opposite sides of the beam cross section (equidistant from the optical axis) in the tangential plane for a beam passing through the beam splitter. One way of achieving this is to cause the angle of incidence of marginal rays in the tangential plane at opposite sides of the beam (equidistant from the optical axis) to enter the beamsplitter at the same angle of incidence. This can help to ensure that the optical path difference between (e.g., outer) rays at opposite sides of the beam cross-section in the tangential plane (as well as in the sagittal plane) is minimised for a beam passing through the beamsplitter.

As an example of how to achieve the above-described function, an ingress face (also referred to as a first face) of the beamsplitter is perpendicular to the optical axis of an optical path between the tube lens and the image sensors. Put another way, the ingress face is arranged so that the optical axis of a beam passing through the tube lens is parallel to a normal of the ingress face. Accordingly, the ingress face has the effect that converging light from the tube lens enters the beamsplitter with an angle of incidence which is substantially independent of the azimuthal angle around the optical axis, only on the radial distance from the optical axis of the beam. Therefore, there is minimal phase delay across the beam. In particular, at the plane of entry into the beamsplitter, a difference in phase between (e.g., outer) rays at opposite sides of the beam cross-section in the tangential plane (as well as in the sagittal plane) is minimised or eliminated. Reducing the differences in angle of incidence and phase delay across the beam reduces or minimises the corresponding degree of astigmatism otherwise introduced across the beam.

In the present disclosure, the term perpendicular includes substantially perpendicular, wherein substantially perpendicular includes, for example, angles in the range 90 degrees+/−2.5 degrees or even +/−5 degrees. Likewise, the term parallel includes substantially parallel, wherein substantially parallel includes, for example, angles in the range 0 degrees+/−2.5 degrees or even +/−5 degrees.

A first egress face (also referred to as a second face) of the beamsplitter is perpendicular to the optical axis of a beam transmitted through the transmission-reflection face. Put another way, the first egress face is arranged so that the optical axis of a beam passing through the tube lens and the beamsplitter is parallel to a normal of the first egress face. The first egress face therefore has the effect that converging light which passes through the beamsplitter and is transmitted through the transmission-reflection face exit the beamsplitter with minimal phase delay across the beam cross section. The angle of incidence of rays within the beam on the first egress plate is substantially independent of the azimuthal angle around the optical axis of the beam (i.e. is only dependent on the radial distance from the optical axis). At the plane of exit from the beamsplitter for light of the first wavelength, a difference in phase between (e.g., outer) rays at opposite sides of the beam cross-section (equidistant from the optical axis) in the tangential plane (as well as in the sagittal plane) is minimised (e.g., eliminated).

In some embodiments, the ingress face and first egress face work together to minimise the astigmatism. For example, the ingress face and first ingress face are arranged relative to each other as well as to the optical axis of the beam from the tube lens (e.g., to the optical axis of the tube lens itself in some implementations) so that astigmatism at the first image sensor is minimised. This can be achieved by arranging the ingress face and first egress face so that the optical path length difference (in the beamsplitter between the ingress face and the first egress face) between marginal rays at opposite sides of the beam cross-section (equidistant from the optical axis) in the tangential plane (as well as the sagittal plane) is minimised (e.g., eliminated) for light transmitted through the transmission-reflection face. In some examples, this is achieved by arranging the first egress face to be parallel to the ingress face.

The transmission-reflection face is arranged oblique to the optical axis of the tube lens so that it deflects light of the second wavelength toward the second image sensor.

In some embodiments, a second egress face (also referred to as a third face) of the beamsplitter is perpendicular to the optical axis of a reflection from the transmission-reflection face. In the case of a transmission/reflection face angled at 45 degrees to the ingress face, the second egress face is perpendicular to the ingress face. For other angles between the ingress face and the transmission-reflection face, the second egress face is arranged relative to the ingress face at an angle of 180 minus double the angle between the ingress face and the transmission-reflection face. Arranging the angle of the second egress face in this way has the effect that converging light rays which pass through the beamsplitter and reflect from the transmission-reflection face exit the beamsplitter with minimal phase delay across the beam cross section. That is, the optical path length through the beamsplitter for rays at a particular radial distance from the optical axis of the beam is independent of the azimuthal angle around the optical axis. As a result, the plane of exit from the beamsplitter for light of a second wavelength, a difference in phase between (e.g., outer) rays at opposite sides of the beam cross-section in the tangential plane (as well as in the sagittal plane) is minimised or eliminated. This can be achieved by arranging the second egress face relative to the transmission-reflection face so that the optical path length difference (in the beamsplitter between the ingress face and the second egress face) between marginal rays at opposite sides of the beam cross-section (equidistant from the optical axis) in the tangential plane (as well as the sagittal plane) is minimised for light reflected by the transmission-reflection face.

Through the arrangement of the ingress face and first egress face, In some embodiments, the beamsplitter has a first transmission channel arranged to transmit a first component of the emission light, via the first egress face, to the first image sensor, and a second transmission channel arranged to transmit a second component of the emission light, via the second egress face, to the second image sensor.

In some embodiments, the ingress and egress faces are planar (flat) so that distortion of the beam is minimised and/or so that the effective focal length of the tube lens and beamsplitter is substantially the same as (e.g., having a minimal difference to) the focal length of the tube lens alone. This can allow ease of manufacture and reduction in cost of the beamsplitter compared with, for example, curved ingress or egress faces (possible by co-design of the tube lens and beamsplitter to focus the light at the image sensor).

In some embodiments, the number of egress faces is not limited to two. For example, if three image sensors are employed, three egress faces and three transmission channels formed by a first and second transmission-reflection face may be provided. In a first transmission channel there is no deflection of light of a first wavelength travelling in a first direction from the tube lens toward a first image sensor via a third egress face. In a second transmission channel (a first reflection channel) there is deflection of light of a second wavelength from the first transmission-reflection face in a second direction toward a second image sensor via a second egress face. In a third transmission channel (a second reflection channel) there is deflection of light of a third wavelength from the second transmission-reflection face in a third direction toward a third image sensor via a third egress face. Each of the egress faces are arranged as 10 described herein relative to the axis of the beam in the respective transmission channels to minimise astigmatism at the respective image sensors.

In some embodiments, the beamsplitter is a cube- or cuboid-shaped (or more generally trapezoidal or rectangular prism-shaped) with an internal dichroic transmission-reflection surface arranged at 45-degree angle with respect to the ingress face. However, embodiments are not limited to this arrangement. For example, faces of the beamsplitter through which no light from the tube lens passes (e.g. the faces other than the ingress and any egress faces) need not be arranged, shaped or angled in any particular way. Nevertheless, such faces may be treated with a light absorbing coating or other light absorbing, reflecting or diffusing surface modification so that stray or ambient light does not enter the beamsplitter and interfere with the image detected at the image sensors. For simplicity of manufacture, such faces may be planar and/or arranged perpendicular to the ingress and/or egress faces.

Each transmission-reflection face described herein may be a dichroic surface arranged to transmit light of a first wavelength and reflect light of a second wavelength different from the first wavelength. In some embodiments, the transmission coefficient for the first wavelength is greater than the transmission coefficient for the second wavelength. In some embodiments, the reflection coefficient for the first wavelength is lower than the reflection coefficient for the second wavelength. In some embodiments, the surface is a long-pass dichroic surface transmitting light of wavelengths longer than a threshold wavelength and reflecting light of wavelengths shorter than the threshold wavelength. In some embodiments, surface is a short-pass dichroic surface transmitting light of wavelengths shorter than the threshold wavelength and reflecting light of wavelengths longer than the threshold wavelength.

However, embodiments are not limited to those including dichroic surfaces. In some embodiments, the transmission-reflection face is a 50/50 beamsplitter. For example, a similar effect can be achieved with a transmission-reflection face which is not wavelength dependent. In this case, wavelength-dependent filters (e.g. bandpass filters) may be applied downstream of the transmission-reflection face (e.g. downstream of the egress faces) to ensure only light of appropriate wavelengths reaches the image sensors. The use of a dichroic transmission-reflection face has an advantage over the use of a non-wavelength dependent transmission-reflection face with the addition of external filters, because transmission efficiencies in the respective transmission channels are relatively higher when external filters are not used. That is, losses can be lower when using a dichroic transmission-reflection face than when using filters.

In some embodiments, the transmission-reflection face is an internal surface within the beamsplitter. For example, the beamsplitter can be formed from two (e.g. right-angled triangular) prisms, with the connecting faces (e.g. hypotenuse faces) of the prisms forming the transmission-reflection surface. Forming the beamsplitter so that faces of the prisms are connected (i.e. in contact) can allow ease of manufacture, mounting, alignment and/or maintenance of the beamsplitter. However, the beamsplitter is not limited to this arrangement.

In the following, embodiments will be discussed in more detail with reference to the appended drawings. It should be understood, however, that the drawings are not intended to limit the present disclosure to the subject-matter depicted in the drawings. The embodiments described with reference to the drawings can be understood in isolation from, as well as in the context of, the concepts set out in the claims, summary and/or overview of the present disclosure.

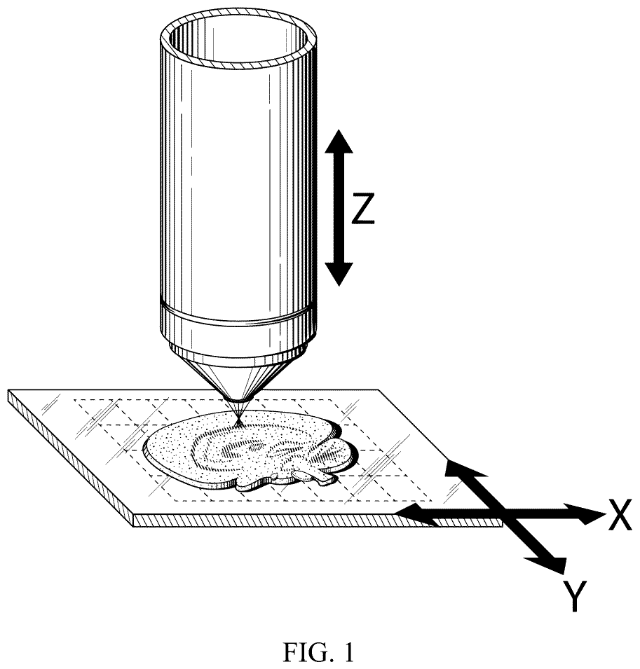

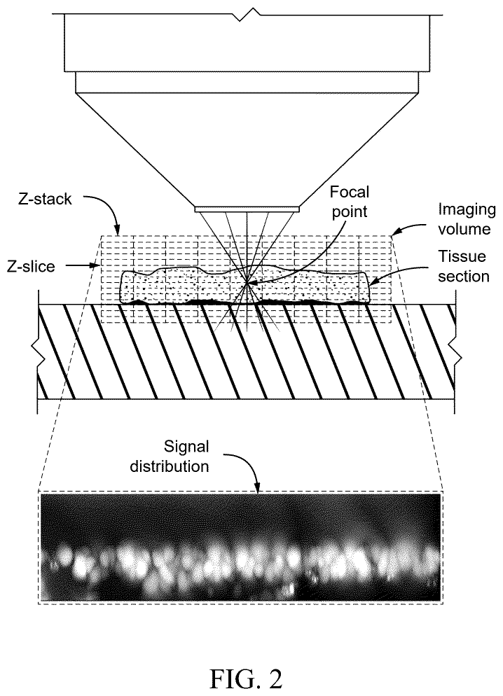

In volumetric sample imaging systems (e.g., an optofluidic instrument), a z-stack of images is obtained for each Field of View (FOV) of the objective (FIG. 1). For such automated, high-throughput tissue imaging applications, automatically identifying relevant regions—those regions that contain target molecules such as nucleic acids or proteins—can be challenging as distribution of tissue is non-uniform in many biological samples (FIG. 2). FIG. 2 depicts the XZ cross-sectional view and illustrates tissue non-uniformity in the Z dimension, where the full (non-reduced) imaging volume 301 is oversampled in the Z dimension. The objective lens focal point 302 is positioned to acquire an image at every Z-slice 303 in a Z-stack 304. An XZ image of signal distribution (bottom) 305 demonstrates a non-uniform distribution of detected signal within the imaging volume. Also depicted in FIG. 2 is the tissue section 306. The data extracted from the detection and analysis methods disclosed herein (e.g., in situ detection and analysis of target analytes, such as SBS, SBL, SBH; and in situ hybridization techniques, such as smFISH and MERFISH) include the relative coordinates within a field of view (FOV) and provides intricate information regarding tissue organization.

In general, the systems and methods described herein use any suitable method to generate contrast of a sample against a background (e.g., illumination of a sample via bright field imaging, illumination of a sample via fluorescent imaging, inducing autofluorescence within the sample, adding contrast to the sample with one or more stains, etc.)

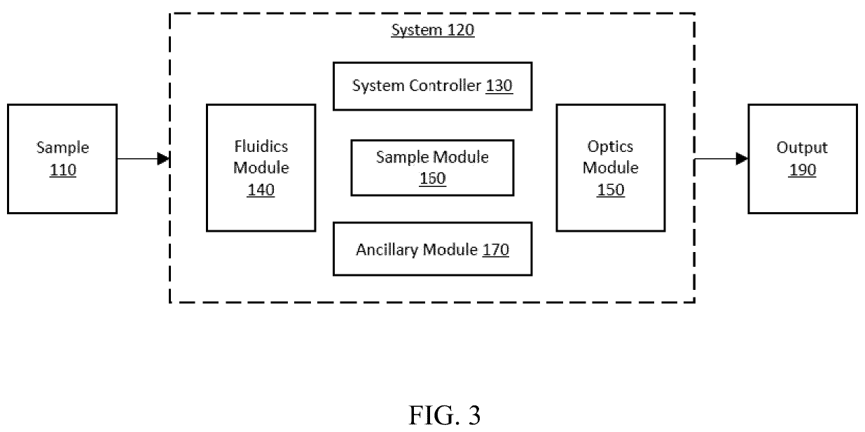

FIG. 3 shows an example workflow of analysis of a biological sample 110 (e.g., cell or tissue sample) using an opto-fluidic instrument 120, according to various embodiments. In various embodiments, the sample 110 can be a biological sample (e.g., a tissue) that includes molecules such as DNA, RNA, proteins, antibodies, etc. For example, the sample 110 can be a sectioned tissue that is treated to access the RNA thereof for labelling with circularizable DNA probes. Ligation of the probes may generate a circular DNA probe which can be enzymatically amplified and bound with fluorescent oligonucleotides, which can create bright signal that is convenient to image and has a high signal-to-noise ratio.

In various embodiments, the sample 110 may be placed in the opto-fluidic instrument 120 for analysis and detection of the molecules in the sample 110. In various embodiments, the opto-fluidic instrument 120 can be a system configured to facilitate the experimental conditions conducive for the detection of the target molecules. For example, the opto-fluidic instrument 120 can include a fluidics module 140, an optics module 150, a sample module 160, and an ancillary module 170, and these modules may be operated by a system controller 130 to create the experimental conditions for the probing of the molecules in the sample 110 by selected probes (e.g., circularizable DNA probes), as well as to facilitate the imaging of the probed sample (e.g., by an imaging system of the optics module 150). In various embodiments, the various modules of the opto-fluidic instrument 120 may be separate components in communication with each other, or at least some of them may be integrated together.

In various embodiments, the sample module 160 may be configured to receive the sample 110 into the opto-fluidic instrument 120. For instance, the sample module 160 may include a sample interface module (SIM) that is configured to receive a sample device (e.g., cassette) onto which the sample 110 can be deposited. That is, the sample 110 may be placed in the opto-fluidic instrument 120 by depositing the sample 110 (e.g., the sectioned tissue) on a sample device that is then inserted into the SIM of the sample module 160. In some instances, the sample module 160 may also include an X-Y stage onto which the SIM is mounted. The X-Y stage may be configured to move the SIM mounted thereon (e.g., and as such the sample device containing the sample 110 inserted therein) in perpendicular directions along the two-dimensional (2D) plane of the opto-fluidic instrument 120.

The experimental conditions that are conducive for the detection of the molecules in the sample 110 may depend on the target molecule detection technique that is employed by the opto-fluidic instrument 120. For example, in various embodiments, the opto-fluidic instrument 120 can be a system that is configured to detect molecules in the sample 110 via hybridization of probes. In such cases, the experimental conditions can include molecule hybridization conditions that result in the intensity of hybridization of the target molecule (e.g., nucleic acid) to a probe (e.g., oligonucleotide) being significantly higher when the probe sequence is complementary to the target molecule than when there is a single-base mismatch. The hybridization conditions include the preparation of the sample 110 using reagents such as washing/stripping reagents, hybridizing reagents, etc., and such reagents may be provided by the fluidics module 140.

In various embodiments, the fluidics module 140 may include one or more components that may be used for storing the reagents, as well as for transporting said reagents to and from the sample device containing the sample 110. For example, the fluidics module 140 may include reservoirs configured to store the reagents, as well as a waste container configured for collecting the reagents (e.g., and other waste) after use by the opto-fluidic instrument 120 to analyze and detect the molecules of the sample 110. Further, the fluidics module 140 may also include pumps, tubes, pipettes, etc., that are configured to facilitate the transport of the reagent to the sample device (e.g., and as such the sample 110). For instance, the fluidics module 140 may include pumps (“reagent pumps”) that are configured to pump washing/stripping reagents to the sample device for use in washing/stripping the sample 110 (e.g., as well as other washing functions such as washing an objective lens of the imaging system of the optics module 150).

In various embodiments, the ancillary module 170 can be a cooling system of the opto-fluidic instrument 120, and the cooling system may include a network of coolant-carrying tubes that are configured to transport coolants to various modules of the opto-fluidic instrument 120 for regulating the temperatures thereof. In such cases, the fluidics module 140 may include coolant reservoirs for storing the coolants and pumps (e.g., “coolant pumps”) for generating a pressure differential, thereby forcing the coolants to flow from the reservoirs to the various modules of the opto-fluidic instrument 120 via the coolant-carrying tubes. In some instances, the fluidics module 140 may include returning coolant reservoirs that may be configured to receive and store returning coolants, i.e., heated coolants flowing back into the returning coolant reservoirs after absorbing heat discharged by the various modules of the opto-fluidic instrument 120. In such cases, the fluidics module 140 may also include cooling fans that are configured to force air (e.g., cool and/or ambient air) into the returning coolant reservoirs to cool the heated coolants stored therein. In some instances, the fluidics module 140 may also include cooling fans that are configured to force air directly into a component of the opto-fluidic instrument 120 so as to cool said component. For example, the fluidics module 140 may include cooling fans that are configured to direct cool or ambient air into the system controller 130 to cool the same.

As discussed above, the opto-fluidic instrument 120 may include an optics module 150 which include the various optical components of the opto-fluidic instrument 120, such as but not limited to a camera, an illumination module (e.g., light source such as LEDs), an objective lens, and/or the like. The optics module 150 may include a fluorescence imaging system that is configured to image the fluorescence emitted by the probes (e.g., oligonucleotides) in the sample 110 after the probes are excited by light from the illumination module of the optics module 150.

In some instances, the optics module 150 may also include an optical frame onto which the camera, the illumination module, and/or the X-Y stage of the sample module 160 may be mounted.

In various embodiments, the system controller 130 may be configured to control the operations of the opto-fluidic instrument 120 (e.g., and the operations of one or more modules thereof). In some instances, the system controller 130 may take various forms, including a processor, a single computer (or computer system), or multiple computers in communication with each other. In various embodiments, the system controller 130 may be communicatively coupled with data storage, set of input devices, display system, or a combination thereof. In some cases, some or all of these components may be considered to be part of or otherwise integrated with the system controller 130, may be separate components in communication with each other, or may be integrated together. In other examples, the system controller 130 can be, or may be in communication with, a cloud computing platform.

In various embodiments, the opto-fluidic instrument 120 may analyze the sample 110 and may generate the output 190 that includes indications of the presence of the target molecules in the sample 110. For instance, with respect to the example embodiment discussed above where the opto-fluidic instrument 120 employs a hybridization technique for detecting molecules, the opto-fluidic instrument 120 may cause the sample 110 to undergo successive rounds of fluorescent probe hybridization (using two or more sets of fluorescent probes, where each set of fluorescent probes is excited by a different color channel) and be imaged to detect target molecules in the probed sample 110. In such cases, the output 190 may include optical signatures (e.g., a codeword) specific to each gene, which allow the identification of the target molecules.

In some instances, an assembly for transilluminating a substrate can include a sample carrier device (e.g., a microfluidic chip or glass slide), a thermal control module configured to control the temperature of the sample carrier device (e.g., a thermoelectric module), and a light source configured to illuminate the sample carrier device. In some instances, the assembly includes a heat exchanger (e.g., a fluid block having a cooling fluid flowing therethrough). In some instances, an assembly for transilluminating can include sample carrier device (e.g., a sample substrate), an optically transparent substrate, a light source configured to illuminate the optically transparent substrate, a light scattering layer configured to scatter light from the light source, and/or a thermal control module configured to control the temperature of the sample carrier device and/or optically transparent substrate.

In some embodiments, the sample carrier device (e.g., a cassette) can be configured to receive a sample. In some embodiments, the sample carrier device can include one or more microfluidic channels, e.g., sample chambers or microfluidic channels etched into a planar substrate or chambers within a flow cell or microfluidic device.

A sample carrier device for the systems disclosed herein can include, but is not limited to, a substrate configured to receive a sample, a microscope slide and/or an adapter configured to mount microscope slides (with or without coverslips) on a microscope stage or automated stage (e.g., an automated translation or rotational stage), a substrate, and/or an adapter configured to mount slides on a microscope stage or automated stage, a substrate comprising etched sample containment chambers (e.g., chambers open to the environment) and/or an adapter configured to mount such substrates on a microscope stage or automated stage, a flow cell and/or an adapter configured to mount flow cells on a microscope stage or automated stage, or a microfluidic device and/or an adapter configured to mount microfluidic devices on a microscope stage or automated stage. In some embodiments, the sample carrier device further includes a cassette configured to secure a substrate (e.g., a glass slide). In some embodiments, the cassette includes two or more components (e.g., a top half and a bottom half) into which the substrate is secured.

In some instances, the one or more sample carrier devices can be designed for performing a variety of chemical analysis, biochemical analysis, nucleic acid analysis, cell analysis, or tissue analysis applications. In some instances, for example, the sample carrier device (e.g., flow cells and microfluidic devices) may comprise a sample, e.g., a tissue sample. In some instances, the sample carrier device (e.g., flow cells and microfluidic devices) may comprise a sample, e.g., a tissue sample, placed in contact with, e.g., a substrate (e.g., a surface of the flow cell or microfluidic device).

The sample carrier devices for the disclosed systems (e.g., microscope slides, substrates comprising one or more etched microfluidic channel, flow cells or microfluidic devices comprising one or more microfluidic channels, etc.) can be fabricated from any of a variety of materials known to those of skill in the art including, but not limited to, glass (e.g., borosilicate glass, soda lime glass, etc.), fused silica (quartz), silicon, polymer (e.g., polystyrene (PS), macroporous polystyrene (MPPS), polymethylmethacrylate (PMMA), polycarbonate (PC), polypropylene (PP), polyethylene (PE), high density polyethylene (HDPE), cyclic olefin polymers (COP), cyclic olefin copolymers (COC), polyethylene terephthalate (PET), polydimethylsiloxane (PDMS), etc.), polyetherimide (PEI) and perfluoroelastomer (FFKM) as more chemically inert alternatives, or any combination thereof. FFKM is also known as Kalrez.

The one or more materials used to fabricate sample carrier devices for the disclosed systems (e.g., substrates configured to receive a sample, microscope slides, substrates comprising one or more etched microfluidic channels, flow cells or microfluidic devices comprising one or more microfluidic channels or sample chambers, etc.) can be optically transparent to facilitate use with spectroscopic or imaging-based detection techniques. In some instances, the entire sample carrier device can be optically transparent. Alternatively, in some instances, only a portion of the sample carrier device (e.g., an optically transparent “window”) can be optically transparent.

The sample carrier devices for the disclosed systems (e.g., substrates configured to receive a sample, microscope slides, substrates comprising one or more etched microfluidic channels, flow cells or microfluidic devices comprising one or more microfluidic channels or sample chambers, etc.) can be fabricated using any of a variety of techniques known to those of skill in the art, where the choice of fabrication technique is often dependent on the choice of material used, and vice versa. Examples of suitable sample carrier device fabrication techniques include, but are not limited to, extrusion, drawing, precision computer numerical control (CNC) machining and boring, laser photoablation, photolithography in combination with wet chemical etching, deep reactive ion etching (DRIE), micro-molding, embossing, 3D-printing, thermal bonding, adhesive bonding, anodic bonding, and the like (see, e.g., Gale, et al. (2018), “A Review of Current Methods in Microfluidic Device Fabrication and Future Commercialization Prospects”, Inventions 3, 60, 1-25, which is hereby incorporated by reference in its entirety).

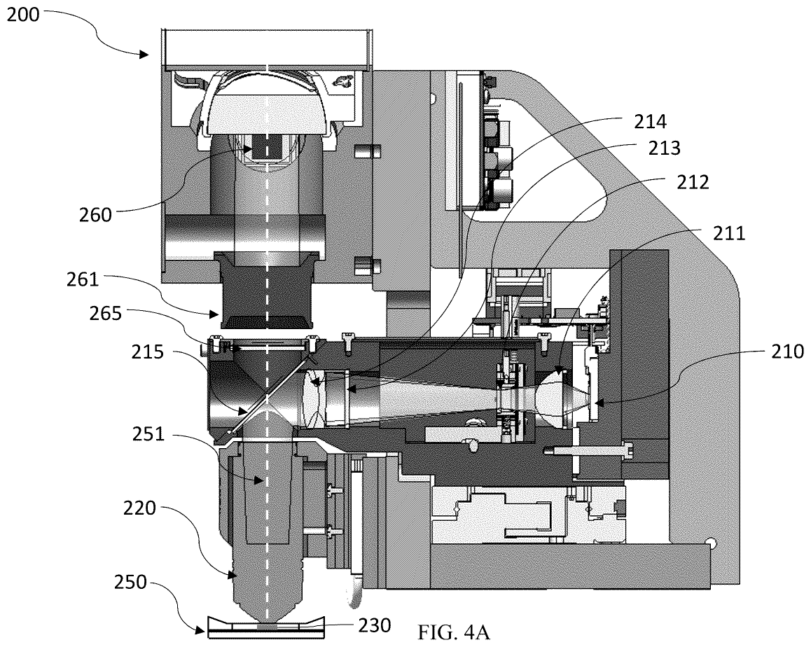

FIG. 4A illustrates a cross-sectional view of an optics module 200 in a comparative imaging system. One or more illumination sources 210, e.g., one or more light emitting diodes (LEDs), provides light through one or more optical components and an objective lens 220 to thereby illuminate a sample 230 in a sample holder 250. In various embodiments, the optical components include a collimator 211. In various embodiments, the optical components include a field stop 212. In various embodiments, the optical components include one or more excitation filters 213. In various embodiments, the one or more excitation filters 213 are configured to filter light from the illumination source(s) 210 for a predetermined range of wavelengths (e.g., each filter has one or more blocking band(s) and/or transmission band(s) that may be different or may overlap at least in part) and each excitation filter 213 is aligned with appropriate illumination sources (e.g., blue LEDs, green LEDs, yellow LEDs, red LEDs, ultraviolet LEDs, etc.). In various embodiments, the optical components include a condenser 214. In various embodiments, the optical components include a beam splitter 215. An optical axis 251 is illustrated extending through the center of the optical surfaces in the objective lens 220 and its path includes an image plane, a focal plane, and input/output pupils (illustrated in FIG. 4B—also showing a comparative imaging system 200 comprising an image plane 401, an object plane 402, a pupil 403, a 1.0 NA 20× objective 404, a 26.5 mm FN tube lens 405 and a small pixel, large sensor, fast readout camera 406).

A sensor array 260 (e.g., CMOS sensor) receives light signals from the sample 230. In various embodiments, the optical components include one or more emission filters 265. In various embodiments, the one or more emission filters 265 are configured to filter light from the sample (e.g., emitted from one or more fluorophores, autofluorescence, etc.) for a predetermined range of wavelengths (e.g., each filter has one or more blocking band(s) and/or transmission band(s) that may be different or may overlap at least in part). In various embodiments, the emission filters 265 align (e.g., via motorized translation) with optics and/or the sensor array. In various embodiments, the sample 230 is probed with fluorescent probes configured to bind to a target (e.g., DNA or RNA) that, when illuminated with a particular wavelength (or range of wavelengths) of light, emit light signals that can be detected by the sensor array 260. In various embodiments, the sample 230 is repeatedly probed with two or more (e.g., two, three, four, five, six, etc.) different sets of probes. In various embodiments, each set of probes corresponds to a specific color (e.g., blue, green, yellow, or red) such that, when illuminated by that color, probes bound to a target emit light signals. In some embodiments, the sensor array 260 is aligned with the optical axis 251 of the objective lens 220 (i.e., the optical axis of the camera is coincident with and parallel to the optical axis of the objective lens 220). In various embodiments, the sensor array 260 is positioned perpendicularly to the objective lens 220 (i.e., the optical axis of the camera is perpendicular to and intersects the optical axis of the objective lens 220). In various embodiments, a tube lens 261 is mounted in the optical path to focus light on the sensor array 260 thereby allowing for image formation with infinity-corrected objectives. Descriptions of optical modules and illumination assemblies for use in opto-fluidic instruments can be found in U.S. provisional patent application No. 63/427,282, filed on Nov. 22, 2022, titled “Systems and Methods for Illuminating a Sample” and U.S. provisional patent application No. 63/427,360, file on Nov. 22, 2022, titled “Systems and Methods for Imaging Samples,” each of which is incorporated by reference in its entirety.

In various embodiments, the sample is illuminated with one or more wavelengths configured to induce fluorescence in the sample. In various embodiments, the sample is probed during one or more probing cycles with one or more fluorescent probes configured to bind to one or more target analytes. In various embodiments, the one or more wavelengths are selected to induce fluorescence in a subset of the one or more fluorescent probes. In various embodiments, each probing cycle includes illumination with two or more (e.g., four) colors of light. In various embodiments, the sample is treated with a fluorescent stain configured to illuminate one or more structures within the sample. In various embodiments, the sample is contacted with a nuclear stain. In various embodiments, the sample is contacted with 4′,6-diamidino-2-phenylindole (“DAPI”) configured to bind to adenine-thymine-rich regions in DNA. In various embodiments, illumination of the sample causes autofluorescence of the sample. In various embodiments, autofluorescence is the natural emission of light by biological structures when they have absorbed light, and may be used to distinguish the light originating from artificially added fluorescent markers. In various embodiments, fluorescence of the sample through fluorescent probes, autofluorescence, and/or a fluorescent stain can be used with the methods described herein to determine one or more focus metrics of a tissue sample.

In various embodiments, the sample is illuminated via edge lighting or transillumination along one or more edges of the sample and/or sample substrate. In various embodiments, the edge lighting provides dark-field illumination of the sample. In various embodiments, edge lighting is provided by one or more light sources positioned to provide light substantially perpendicular to a normal of the substrate surface on which the sample is disposed. In various embodiments, the substrate is a glass slide. In various embodiments, the substrate is configured as a wave guide to thereby guide light emitted from the edge lighting towards the sample. In various embodiments, illumination of the sample via edge lighting can be used with the methods described herein to determine one or more focus metrics of a tissue sample.

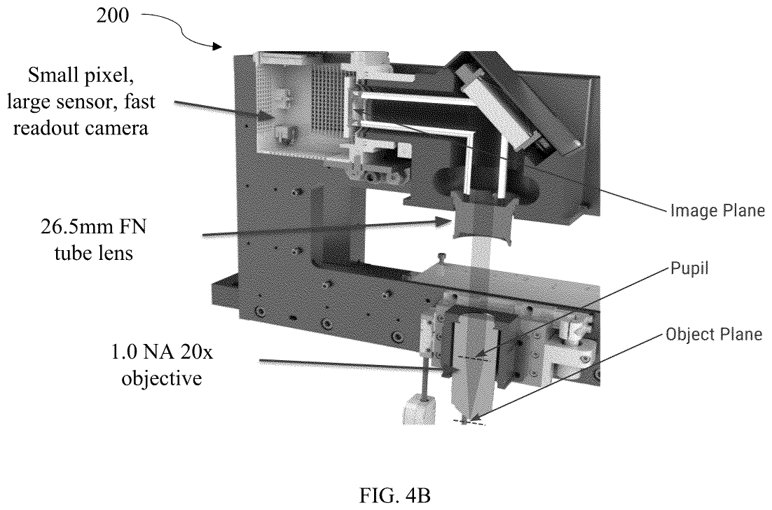

Referring now to FIG. 5, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments described herein.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to microcode, device drivers, redundant processing units, external disk drive arrays, RAID systems, tape drives, and data archival storage systems, etc.

The present disclosure includes systems, methods, and/or computer program products. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

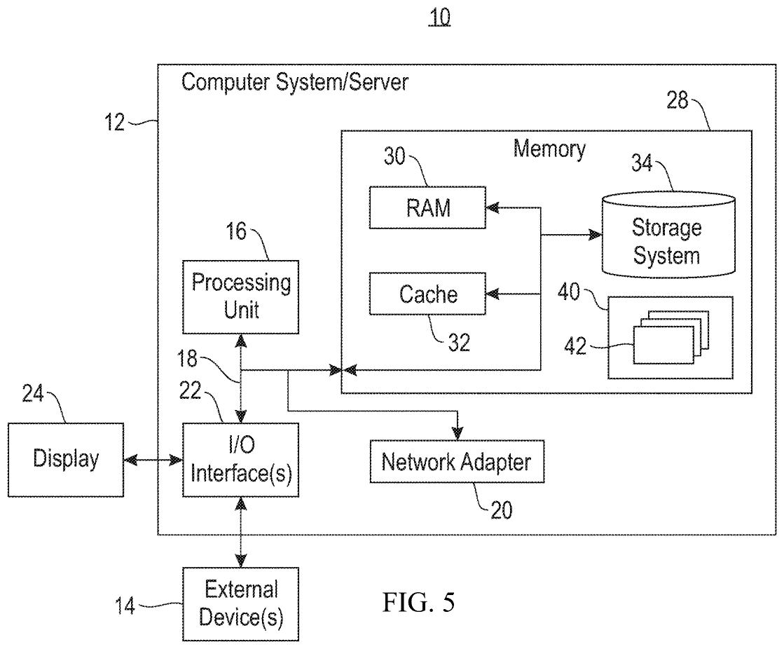

FIG. 6 illustrates a dual camera imaging system 600 for fluorescence microscopy. The dual camera imaging system can be as described below and optionally can be based on (and include any or all features of) the optics module and/or the imaging system and/or the computer node described with reference to FIGS. 1-5. The dual camera imaging system 600 includes an objective 602, a dichroic plate 604, two tube lenses (first tube lens 606a, second tube lens 606b), and two image sensors (first image sensor 608a, second image sensor 608b). In some examples, the image sensors 608a, 608b are cameras, CCD or CMOS image sensors. In this setup, the objective 602 is an infinity corrected objective focused at a focal plane arranged collect emission light from a sample 610 (e.g., emission light at one or more focal plane) and collimate the emission light in the pupil conjugate. The collimated emission light is transmitted from the objective 602 to the tube lenses 606a, 606b through the infinity space 612. In some embodiments, a z-distance between the objective and sample is adjusted one or more times to thereby image additional focal planes (i.e., z-slices) within a field of view (FOV) of the objective 602. In some embodiments, a plurality of z-slices of a FOV form a z-stack of images representing an image volume.

The dichroic plate 604 (also known as a dichroic mirror or filter) is positioned to intersect the emission light path in the infinity space 612. The dichroic plate 604 has wavelength dependent reflectivity such that the dichroic plate 604 is configured to transmit a first component of the emission light (e.g., a first spectral range) and to reflect a second component of the emission light (e.g., a second spectral range). In some embodiments, the first spectral range includes a first peak wavelength corresponding to a first fluorophore (e.g., a red, yellow, green, or blue dye). In some embodiments, the second spectral range includes a second peak wavelength corresponding to a second fluorophore (e.g., a red, yellow, green, or blue dye). A first component of the emission light is transmitted through the dichroic plate 604 and to the first tube lens 606a, while a second component of the emission light is reflected by the dichroic plate 604 and travels to the second tube lens 606b. The dichroic plate 604 is angled obliquely with respect to the emission light path in the infinity space 612. In some embodiments, the dichroic plate 604 is angled at 45 degrees to a plane perpendicular to the optical axis of the objective 602. In some embodiments, the dichroic plate 604 is angled at 30 degrees to a plane perpendicular to the optical axis of the objective 602. At the respective first and second tube lenses 606a and 606b, the first and second components of emission light are respectively focused at first and second image sensors 608a and 608b. The image sensors 608a and 608b then capture images of the components of emission light. Each tube lens 606a, 606b is configured to focus the light transmitted from the objective and form an image on the respective image sensor 608a, 608b.

Accordingly, the system of FIG. 6 finds use in imaging a sample 610 having one or more target analytes tagged with at least two fluorophores (e.g., red, yellow, green, blue). In some embodiments, each fluorophore is simultaneously or sequentially excited by excitation light. The excitation light for each fluorophore includes at least a portion of the respective fluorophore-dependent excitation wavelengths for exciting each fluorophore in the sample. In response, the fluorophores emit emission light, which is directed through the objective, the infinity space 612 and is split by the dichroic plate 604 into two components each corresponding to a different fluorophore. In some embodiments, each beam of emission light is passed through an optical filter (e.g., a long pass filter, a short pass filter, a band pass filter) to filter out one or more wavelengths of light. A first component of the emission light (corresponding to a component of the emission light from one of the fluorophores) is transmitted through the dichroic plate 604 and the first tube lens 606a. The image of the first component of emission light is then captured by the first image sensor 608a. Similarly, a second component of the emission light (corresponding to a component of the emission light from another of the fluorophores) is reflected by the dichroic plate 604 and travels to the second tube lens 606b. The image of the second component of emission light is then captured by the second image sensor 608b. The images captured by the first and second image sensors 608a and 608b are combined by superimposition to generate a compound image of emission light.

As explained above, while optical components (e.g., components corresponding to peripheral functions of the microscopes) can be positioned within the infinity space without introducing aberration, the amount of available infinity space is limited. Example components include, for instance, components of an autofocus module for detecting a sample position relative to the focal plane 610 and moving the sample in response to the detection, and components of an excitation light injection module to introduce collimated excitation light (also referred to as illumination light) in the infinity space. In some embodiments, the infinity space is about 50 mm to about 200 mm measured between the objective 602 and the first tube lens 606a. In some embodiments, the infinity space is about 100 mm to about 200 mm measured between the objective 602 and the first tube lens 606a. In some embodiments, the infinity space is about 120 mm to about 160 mm measured between the objective 602 and the first tube lens 606a. In some embodiments, the infinity space is about 50-200 mm (e.g. about 100 mm) measured between the objective 602 and the first tube lens 606a, but the size of the infinity space is not limited thereto. Since the plate dichroic takes up a portion of the infinity space, a problem exists in how to increase availability of infinity space for components needed for peripheral functions without significantly increasing the cost of the instrument as a whole (e.g., two tube lenses 606a, 606b would cost twice as much as a single tube lens).

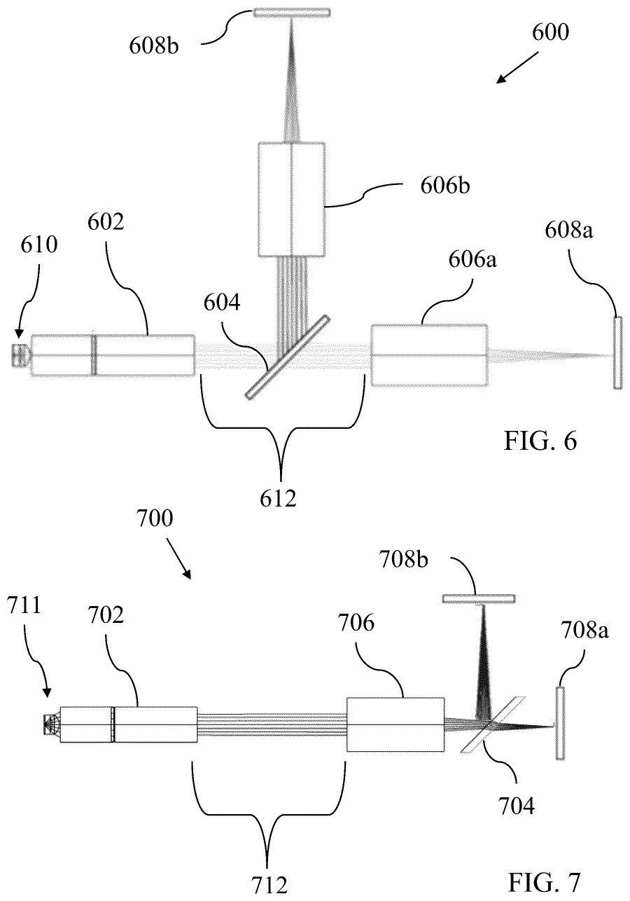

FIG. 7 illustrates an imaging system 700 for fluorescence microscopy. The imaging system 700 of FIG. 7 differs from the dual camera imaging system 600 of FIG. 6 in that the dichroic plate 704 of FIG. 7 is positioned outside (or after or downstream of) the tube lens 706. In other words, the dichroic plate 704 is positioned to intersect the emission light downstream from and/or after passing through the tube lens 706. In this way, the dichroic plate is neither in the pupil conjugate nor the field conjugate and is positioned between the tube lens and the image sensor. Accordingly, the imaging system 700 increases infinity space availability and/or allows for the infinity space to be reduced in size. As described above, the imaging system 700 also does not require a second tube lens and can therefore be cheaper to manufacture (i.e., have a lower bill of materials cost).

In operation, the objective 702 of the alternative imaging system 700 collects emission light from a sample (e.g., at one or more focal planes). The emission light is then transmitted from the objective 702, through the infinity space 712, and to the tube lens 706. The emission light is focused by the tube lens 706 onto the first and second image sensors 708a, 708b via the dichroic plate 704. As with the dual camera imaging system 100 of FIG. 6, the dichroic plate 704 shown in FIG. 7 has wavelength-dependent reflectivity such that the dichroic plate 704 is configured to transmit a first component of the emission light (e.g., a first spectral range) and to reflect a second component of the emission light (e.g., a second spectral range). The dichroic plate 704 is also angled obliquely with respect to the emission light path. That is, the transmission-reflection face of the dichroic plate is angled obliquely with respect to the optical axis of the tube lens. The first component of the emission light having a first spectral range (e.g., including a first peak wavelength) is transmitted through the dichroic plate 704 and travels to the first image sensor 708a, while the second component of the emission light having a second spectral range (i.e., including a second peak wavelength) is reflected by the dichroic plate 704 and travels to the second image sensor 708b.

In this setup, the beams of the emission light are converging on intersection with the dichroic plate 704 positioned after the tube lens 706. In some embodiments, astigmatism is introduced in at least the first image sensor 708a when the dichroic plate 704 is positioned after the tube lens 706. The oblique angle of the dichroic plate in combination with the emission light convergence introduces an astigmatism in the light transmitted through the dichroic plate 704 to the first image sensor 708a. The astigmatism arises because the optical path length through the dichroic plate 704 is different for marginal rays at opposite sides of the beam cross section (equidistant from the optical axis) in the tangential plane. Put another way, the optical path length for rays at equal radius with respect to the optical axis is dependent on (and varies according to) the azimuthal angular position around the optical axis. This causes light in the tangential plane to be focused at a shorter distance than light in the sagittal plane. In FIG. 7, the tangential plane is in the plane of the page and comprises the optical axis of the imaging system 700 (i.e., the optical axis of the optical path of the emission light or the optical axis of the tube lens). The sagittal plane in FIG. 7 is perpendicular to the plane of the page (and therefore perpendicular to the tangential plane) and includes the optical axis of the imaging system 700.

The skilled person can use standard optical design and performance assessment principles such as geometric ray tracing and/or programs such as ZEMAX® optical design program (ZEMAX Development Corporation) to determine the angle of incidence of rays entering and exiting the beamsplitter through its ingress and egress faces, the resultant optical path length through the beamsplitter for those rays, the resultant phase delay across the beam and the degree of astigmatism at the first and second image sensors 708a, 708b. The same techniques can be used to assess other characteristics of the beam at the image sensors, including field curvature within a depth of field for each colour channel (i.e. each component of emission light), axial chromatic shift, lateral chromatic shift, and other aberrations.

Astigmatism greater than the diffraction limit at the first image sensor 708a has been shown in simulations of the imaging system of FIG. 7. In these simulations, the objective numerical aperture (NA) was taken to be 1, the field of view (FOV) was taken to be 1.1 mm, the wavelength of light was taken to be 525 nm, and an exit pupil diameter of the objective and tube lens was taken to be 18 mm. The exit pupil diameter for the overall system was taken to be 4.1 mm. Under these conditions, a root mean squared (RMS) astigmatism of 1.1462 waves was found in a simulated transmission through a dichroic plate 704 of thickness 2 mm and refractive index 1.47 @ 640 nm. The RMS astigmatism value for the system of FIG. 7 far exceeds the diffraction limit of 0.075 RMS waves, which may negatively affect the resulting images at the sensors. A need therefore exists for an alternative solution to minimise the optical path difference between tangential rays and sagittal rays of emission light passing through the beamsplitter dichroic.

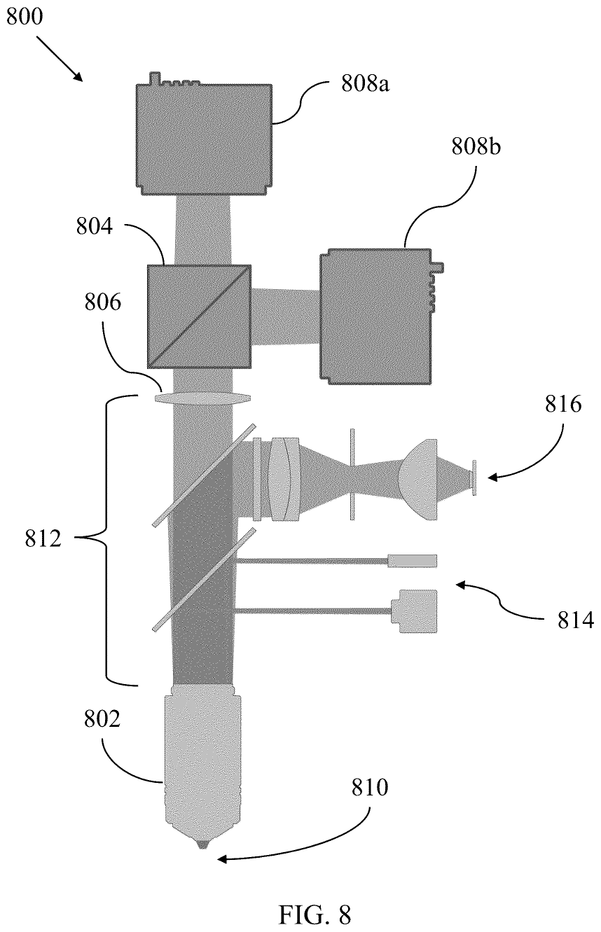

FIG. 8 shows an imaging system 800 suitable for use in fluorescence microscopy with more than one color of fluorophore (e.g., dual color). As an example, the imaging system 800 is configured to generate a compound image of emission from multi-fluorophore emission in a sample.

As shown in FIG. 8, the imaging system 800 includes an objective 802, a tube lens 806, a beamsplitter 804, a first image sensor 808a, and a second image sensor 808b. In some embodiments, the first and second image sensors 808a, 808b include any suitable image sensors for detecting the emission light, such as at least one photodiode array, at least one CCD sensor or camera, and/or at least one CMOS sensor or camera. In some embodiments, the objective 802 is an infinity corrected objective arranged to collect emission light from a sample 810 and to collimate the emission light (i.e. focus the emission light at infinity). The objective 802 is positioned to direct emission light from the sample 810 to the tube lens 806. The collimated emission light is transmitted from the objective 802 to the tube lens 806, through the infinity space 812. The emission light is focused (i.e., rays are converged) by the tube lens 806. The first image sensor 808a and the second image sensor 808b are positioned to receive the focused emission light from the tube lens via a beamsplitter 804. In some implementations, the imaging system includes only one (i.e. a single) tube lens 806, which reduces the total cost of imaging system manufacture.

With continuing reference to FIG. 8, the beamsplitter 804 is disposed between the tube lens 806 and the first image sensor 808a. In some embodiments, the beamsplitter 804 is configured to split the emission light between the first and second image sensors 808a, 808b. In other words, the beamsplitter 804 is arranged to direct a first component of the emission light to the first image sensor 808a and to direct a second component of the emission light to the second image sensor 808b. In some embodiments, when a sample 810 is provided at the focal plane of the objective 802, each component of the emission light corresponds to emission from respective fluorophores in the sample. For example, the first component of emission light corresponds to emission from a first fluorophore in the sample and the second component of emission light corresponds to emission from a second fluorophore in the sample.

In some implementations, the beamsplitter 804 is arranged to split the emission light via a first transmission channel and a second transmission channel of the beamsplitter 804. The first component of the emission light is transmitted to the first image sensor 808a via the first transmission channel. Similarly, the second component of emission light is transmitted to the second image sensor 808b via the second transmission channel. In embodiments where the emission light is reflected within the beamsplitter 804, the second translation channel can also be labelled a reflection channel.

In some implementations, such as those where each component of the emission light corresponds to emission from respective fluorophores, each component of emission light includes a respective unique wavelength or spectral range. For instance, the first component of emission light (e.g., corresponding to emission from a first fluorophore in the sample) has a first peak wavelength and the second component of emission light (e.g., corresponding to emission from a second fluorophore in the sample) has a second peak wavelength. In some embodiments, the first peak wavelength corresponds to a wavelength of emission from the first fluorophore and the second peak wavelength corresponds to a wavelength of emission from the second fluorophore.

In some implementations where each component of emission light has a respective unique wavelength or spectral range, the beamsplitter 804 is wavelength-dependent (for example, a dichroic beamsplitter). In other words, the beamsplitter is arranged to split the emission light into respective components, each with a different wavelength from the others. In some implementations, the beamsplitter 804 is a dichroic beamsplitter and includes at least one dichroic face. For instance, in some implementations where the beamsplitter 804 includes a transmission-reflection face, the dichroic surface is the transmission-reflection face. In such implementations, the dichroic surface is arranged to transmit light of the first wavelength (e.g. emission light from a first fluorophore) and reflect light of the second wavelength (e.g. emission light from a second fluorophore).

Beamsplitters having a dichroic surface (transmission-reflection face) can be particularly useful where components of emission light have low light intensity because the dichroic surface efficiently reflects and transmits each component respectively, without significant loss due to absorption. In some embodiments, beamsplitters with a dichroic surface increase the sensitivity of the imaging system 800.

In some implementations (not shown), the beamsplitter 804 is wavelength-independent (in other words, is arranged to split the emission light, independent of wavelength) and is part of a beamsplitter apparatus further comprising respective optical filters associated with each egress face. In some embodiments, the optical filters can be integrated into the egress faces or provided downstream therefrom as a separate component. In some embodiments, the beamsplitter is any beamsplitter suitable for splitting the beam of light into a transmitted and reflected beam, such as a 50-50 beamsplitter, a cube beamsplitter comprising two triangular glass prisms adhered together at their hypotenuse faces, or polarising or non-polarising cube beamsplitters.

In some embodiments, the optical filters are respectively arranged to selectively transmit light of a particular wavelength or wavelengths, while absorbing or reflecting light of other wavelengths. For instance, a first optical filter is disposed at or downstream of a first egress face of the beamsplitter 804 and a second optical filter is disposed at or downstream of a second egress face of the beamsplitter 804. The first optical filter is selected and/or arranged to transmit light of the wavelength or spectral range of wavelengths of the first component of emission light. The second optical filter is selected and/or arranged to transmit light of the wavelength or wavelengths of the second component of emission light. In implementations, each of the first and second filters include any suitable filter for selectively transmitting light of a particular wavelength or spectral range of wavelengths, such as a dyed filter, a reflective filter, and absorptive filter or an interference coating. These implementations can be particularly useful, particularly when components of emission light have high light intensity.

The first transmission channel and/or the second transmission channel is arranged to minimise the optical path difference between tangential rays and sagittal rays of emission light passing through the beamsplitter 804. For instance, the first transmission channel of the beamsplitter 804 is arranged such that the optical path difference between tangential rays and sagittal rays passing therethrough is less than substantially 1 wavelength, 0.75 wavelengths, 0.5 wavelengths, or 0.25 wavelengths thereof. Minimising the optical path difference between tangential rays and sagittal rays passing through the first transmission channel of the beamsplitter 804 minimises the astigmatism introduced by the beamsplitter 804 in the first transmission channel. In more detail, the arrangement of the beamsplitter of FIG. 8 is such that rays in the tangential plane (in the plane of the page in FIG. 8) spaced at a certain distance from the optical axis have the same optical path length through the beamsplitter as rays in the sagittal plane (into the page in FIG. 8) spaced at the same distance from the optical axis. The difference between the optical path length through the beamsplitter for marginal rays at opposite sides of the beam cross-section in the tangential plane is minimised by the shape of the beamsplitter, thereby minimising or eliminating astigmatism introduced by the beamsplitter. In some embodiments, the astigmatism is reduced to below the diffraction limit of 0.075 RMS waves. For instance, the astigmatism (RMS error) is reduced to below 0.07, below 0.065, below 0.06, below 0.055, or below 0.05 waves.

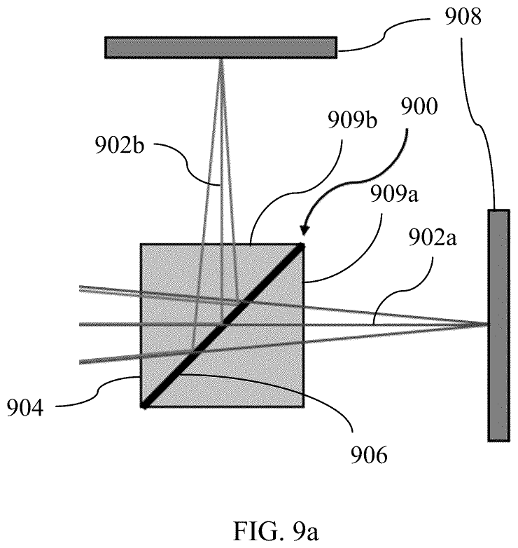

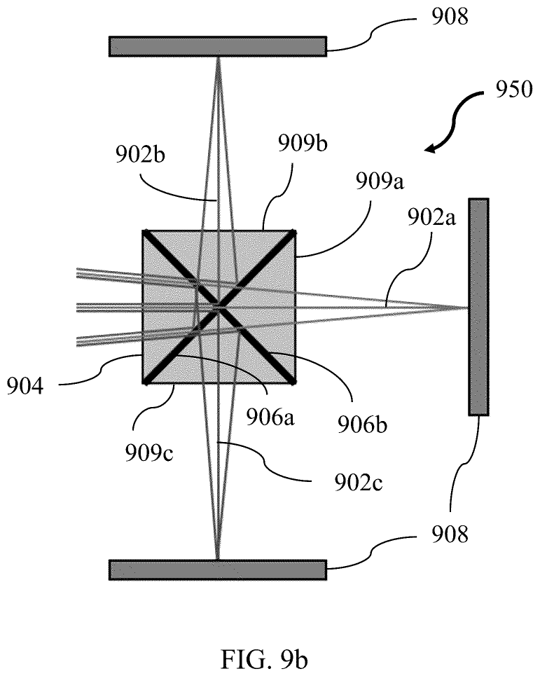

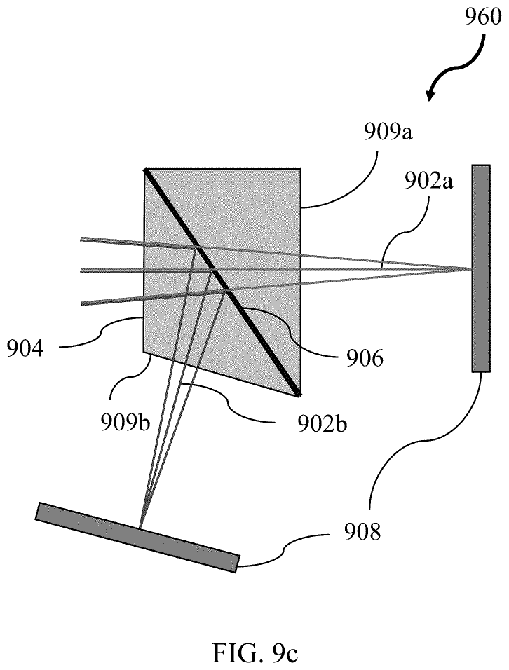

An effect of the beamsplitter 804 according to the present disclosure is that infinity space availability is increased. Additionally, the beamsplitter 804 can be positioned in the optical path between the tube lens and the first and second image sensors while minimising astigmatism. The imaging system 800 including beamsplitter 804 therefore only requires one (i.e. a single) tube lens, and thus can be manufactured at lower cost. Implementations of the beamsplitter are described in more detail herein particularly with respect to FIGS. 9a and 9b.

In some embodiments, as shown in FIG. 8, the imaging system 800 includes an autofocus module 814 and an excitation light injection module 816. In some embodiments, the autofocus module 814 assists in focusing a sample at the focal plane 810 of the objective 802. In some embodiments, the autofocus module 814 is configured to find a surface (e.g., a top surface) of the sample. The excitation light injection module 816 introduces collimated excitation light (also referred to as illumination light) into the infinity space 812 to allow for epifluorescence microscopy. In some embodiments, the autofocus module 814 is optional and can be omitted or adapted from the implementation depicted in FIG. 8. In some embodiments, excitation light is introduced by illuminating the sample using transillumination.

FIGS. 9a and 9b show exemplary beamsplitters 900, 950 suitable for use in the imaging system 800 of FIG. 8. Representative rays 902a, 902b, 902c (or optical paths) for each component of emission light are also shown. Each ray travels along its optical axis. Ray 902a represents the first component of emission light passing through the first transmission channel of the beamsplitter 900, 950. Ray 902b represents the second component of emission light passing through the second transmission channel (also referred to as the reflection channel). In FIG. 9b, ray 902c represents a third component of emission light passing through a third transmission channel of the beamsplitter 950. For illustrative purposes, FIGS. 9a and 9b depict rays 902a, 902b, 902c as separated (that is, not intersecting or overlapping). However, in practice, the optical path and optical axes of each of the components of emission light upstream of the beamsplitter 900, 950 is substantially the same. When positioned in the imaging system of FIG. 8, rays 902a, 902b, 902c therefore represent the optical axes of components of emission light between the tube lens 806 and the first and second image sensors 808a, 808b.

As shown, the beamsplitter 900 of FIG. 9a includes an ingress face 904, a transmission-reflection face 906, a first egress face 909a and a second egress face 909b. In some embodiments, the ingress face 904 may be referred to as a first face, the first egress face 909a may be referred to as a second face, and the second egress face 909b may be referred to as a third face. When positioned in the imaging system of FIG. 8, the ingress face 904 is perpendicular to an optical axis of the emission light from the tube lens. The ingress face 904 is shown in FIG. 9a as perpendicular relative to rays 902a and 902b. The emission light enters the beamsplitter 900 via the ingress face 904. The transmission-reflection face is disposed and/or positioned to then intersect the path of emission light. As described in more detail herein, the transmission-reflection face is arranged to transmit the first component of emission light (as indicated by ray 902a), and to reflect a second component of emission light (as indicated by ray 902b). In implementations, each component of emission light comprises different wavelengths. The transmitted, first component of emission light passes to the first egress face 909a, where the first component exits the beamsplitter 900. The first egress face 909a is perpendicular to the optical axis of the emission light transmitted through the transmission-reflection face. The reflected, second component of emission light passes to the second egress face 909b, where the second component exits the beamsplitter 900. The second egress face 909b is perpendicular to the optical axis of the emission light reflected from the transmission-reflection face 906. In some embodiments, the transmission-reflection face 906 is a long pass filter. In some embodiments, the transmission-reflection face 906 is a short pass filter.

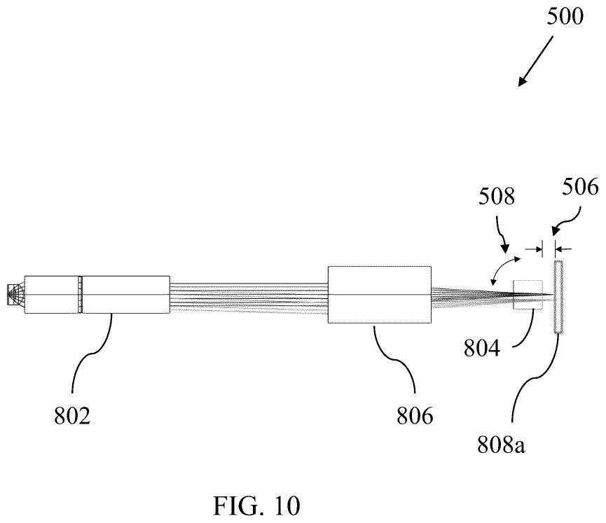

As described herein with respect to FIG. 7, an obliquely angled dichroic plate 704 placed in the path of a converging beam of emission light introduces astigmatism in the light transmitted through the dichroic plate 704 due to differences in angle of incidence leading to an optical path difference between tangential rays and sagittal rays through the dichroic plate 704. The beamsplitter 900, 950 described herein addresses this problem. The beamsplitter 900, 950 is arranged such that the emission light and components thereof pass through the beamsplitter substantially perpendicularly to the beamsplitter face. In other words, the angle of incidence of the central portion (e.g. a central ray) of the beam of light at each face of the beamsplitter is 90° or substantially 90°. Rays further from the central axis of the beam may have an angle of incidence that varies by about +/−5 degrees from the angle of incidence of the central ray, due to the convergence of the light from the tube lens. This reduces the difference in optical path length through the beamsplitter between marginal rays at opposite sides of the beam cross-section in the tangential plane. It also reduces the difference in optical path length through the beamsplitter 900, 950 between marginal rays in the tangential plane at a certain distance from the optical axis and marginal rays in the sagittal plane at the same distance from the optical axis compared with the dichroic plate 704 of FIG. 7. As such, the beamsplitter 900, 950 minimises the astigmatism introduced, even though it is positioned after the tube lens 806 of the imaging system 800 of FIG. 8. As described in more detail herein, particularly with respect to FIG. 10, the beamsplitter 900 may introduce an astigmatism (e.g., a vertical astigmatism or error in the Z₂² polynomial) at the image sensor of less than 0.075 RMS waves of the component of emission light passing through the respective transmission channel. This value for astigmatism is measured substantially at the circle of least confusion and is below the diffraction limit (RMS error of 0.075 waves).

Put more generally, the beamsplitter 900 includes a first transmission channel and a second transmission channel (also referred to as a reflection channel). When positioned in the imaging system 800 of FIG. 8, the first transmission channel of the beamsplitter 900 is arranged to transmit or guide a first component of the emission light to the first image sensor and the second transmission channel is arranged to transmit or guide a second component of the emission light to the second image sensor. For example, the first transmission channel comprises the optical path of ray 902a in FIG. 9a and the second transmission channel comprises the optical path of ray 902b in FIG. 9b. The beamsplitter 900 according to the present disclosure reduces (e.g., minimises) the amount of astigmatism introduced by minimising the optical path difference between tangential plane marginal rays and sagittal plane marginal rays as described herein in each channel. Therefore, the first transmission channel and/or the second transmission channel is arranged such that such an optical path difference in each channel is less than 1 wavelength, less than 0.75 wavelengths, less than 0.5 wavelengths or less than 0.25 wavelengths of the respective component.

In some implementations, the first egress face 909a is parallel to the ingress face 904 and the second egress face 909b is perpendicular to the ingress face 904. In some embodiments, the faces need not be orthogonal provided the respective faces are positioned to intersect the respective optical axes of the emission light passing therethrough at least substantially perpendicularly.

For example, in some implementations, the first egress face 909a is off-parallel to the ingress face 904 and/or the second egress face 909b is off-perpendicular to the ingress face 904. In some embodiments, the transmission-reflection face 906 is positioned to direct a transmission therethrough to pass perpendicularly to the first egress face 909a and to direct a reflection therefrom to pass perpendicularly to the second egress face 909b. For instance, if the emission light refracts at the transmission-reflection face 906, the first egress face 909a is positioned to account for the refraction. Such a beamsplitter could be manufactured from two glass prisms of different refractive indices joined at one face coated to achieve the beamsplitting function as described herein (e.g. including a dichroic coating or 50/50 beamsplitting coating). Similarly, if the transmission-reflection face 906 is not angled at 45° with respect to the ingress face 904, such that second component of emission light is not reflected perpendicularly, the second egress face 909b is positioned to account for the angle of reflection. An example of this is provided in FIG. 9c described below. The angular relationship between the optical axis of the tube lens (or the converging beam from the tube lens, at the ingress face), the ingress face, the transmission-reflection face and the second egress face is such that the optical axis of the emission light is perpendicular to the ingress face on entering the beamsplitter and perpendicular to the second egress face on exiting the beamsplitter. For example, if the angle between the optical axis of the beam entering the ingress face and the ingress face is 90 degrees and the angle between the ingress face and transmission-reflection face is θ, then the angle between the ingress face and the second egress face will be (180 minus 2θ) degrees.

In some embodiments, beamsplitter 900 is a cube beamsplitter. In these implementations, the beamsplitter is shaped as a cube, or otherwise substantially cuboid, with the ingress face 904, first egress face 909a, and second egress face 909b comprising three of its six faces. In some embodiments, the beamsplitter 900 is not be shaped as a cube provided the respective ingress and egress faces are positioned to intersect the respective optical axes passing therethrough at least substantially perpendicularly. In other words, the faces of the beamsplitter 900 other than the ingress face 904, first egress face 909a, and second egress face 909b can take substantially any shape, form or configuration provided it satisfies at least one of the functions or operations of the beamsplitter 900 described herein. For example, the beamsplitter may take the form of a trapezoidal prism satisfying these functions or operations. Other shapes outside of trapezoidal prisms are also contemplated. For example, faces of a trapezoidal prism other than the ingress and egress faces may be modified to take any shape, planar, spherical, polynomial or otherwise. Therefore, in other implementations, the beamsplitter 900 may or may not be a trapezoidal-, cuboid-, or cube-shaped beamsplitter.

In some implementations, at least one of the ingress face 904, the first egress face 909a, and/or the second egress face 909b, is flat. Flat ingress and/or egress faces allow the beamsplitter to be easily manufactured using available methods of polishing optical components such as continuous pitch polishing, bowl feed polishing, bonnet polishing, slurry jet polishing, contact polishing and/or by using any of polishing pads or ultra-polishing pads.

In some implementations, the transmission-reflection face 906 is angled obliquely with respect to the ingress face 904. As an example, the transmission-reflection face 906 of the depicted beamsplitter 900 is angled at 45° or substantially 45° with respect to the ingress face 904. In some embodiments, the transmission-reflection face 906 is angled at about 20° to about 80°. In some embodiments, the transmission-reflection face 906 is angled at about 30° to about 60°. In some embodiments, the transmission-reflection face 906 is angled at about 30°.

In some embodiments, the beamsplitter includes two right-angled prisms affixed to one another and the transmission-reflection face 906 comprises a hypotenuse face of one or both of the two right-angled prisms. The right-angled prisms are affixed to one another by any suitable means, such as by adhesive bonding or thermal bonding. Suitable adhesives include polyester, epoxy, or urethane-based adhesive. For example, a right-angled prism is an optical element which can take the cross-sectional shape of a 45-degree right-angled triangle and is arranged to deviate a light path by 90°—when light is normally incident on a short edge to pass into the prism—via total internal reflection or otherwise by arrangement of the transmission-reflection surface, such as by coating thereof. In some embodiments, either or both right-angle prisms are comprised of UV Fused Silica, Borosilicate Crown glass (such as N-BK7), CaF₂, and/or ZnSe.

In some implementations, the beamsplitter 900 is a dichroic beamsplitter. A dichroic beamsplitter is a beamsplitter arranged to split a beam of light into two beams with different wavelengths or wavelength ranges. For example, in implementations of the imaging system of FIG. 8, where each component of emission light has a respective unique (different) wavelength, the beamsplitter 804 is a dichroic beamsplitter. Here, the beamsplitter is arranged to split the emission light from a sample into a first component of a first wavelength and a second component of a second wavelength. Accordingly, the beamsplitter may be selected according to the particular fluorophores in the sample being imaged, where the wavelength or wavelength range of each beam after the split corresponds to a respective fluorophore in the sample.

In some embodiments, the beamsplitter 900 of FIG. 9a is made dichroic by a dichroic transmission-reflection face 906. In other words, the beamsplitter 900 is made dichroic by selecting and/or arranging the transmission-reflection face 906 to split a beam of light into two beams with different wavelengths. As an example, a dichroic transmission-reflection face includes a dichroic mirror or dichroic reflector.

Where the transmission-reflection face 906 is a dichroic transmission-reflection face, the dichroic transmission-reflection face is manufactured by any suitable means, such as by coating the adjoining face one of the two right-angle prisms comprising the beamsplitter 900 with a dichroic coating prior to affixing the right-angle prisms to one another. The adjoining face may be the hypotenuse of at least one of the two right-angle prisms. The dichroic coating includes, for example, alternating layers of optical coatings with different refractive indices to produce wavelength-dependent reflectivity via interference.

In other implementations to those in which the beamsplitter is a dichroic beamsplitter 900, the beamsplitter comprises a 50-50 beamsplitter, such as a 50-50 cube beamsplitter. The 50-50 beamsplitter is arranged to split light wavelength-independently. In some of these implementations, the beamsplitter 900 is a beamsplitter apparatus which comprises a beamsplitter element and optical filters at or downstream of each egress face 909a, 909b of the beamsplitter element. The optical filter associated with the first egress face is arranged to transmit light of a first wavelength—such as the wavelength of the first component of emission light emitted by a first fluorophore in the sample—and to block other wavelengths including at least a second wavelength. The optical filter of the second egress face is arranged to transmit light of the second wavelength—such as the wavelength of the second component of emission light emitted by a second fluorophore in the sample—and to block other wavelengths including at least the first wavelength.

The beamsplitter 950 of FIG. 9b is similar to the beamsplitter of FIG. 9a in that both beamsplitters 900, 950 include an ingress face 904, a first egress face 909a, and a second egress face 909b. These corresponding faces of FIG. 9b are as described with respect to FIG. 9a. However, the beamsplitter 950 of FIG. 9b differs from the beamsplitter 900 of FIG. 9a in that the transmission-reflection face is a first transmission-reflection face 906a and that the beamsplitter further comprises a second transmission-reflection face 906b. The beamsplitter 950 of FIG. 9b also includes a third egress face 909c.

Like the first transmission-reflection face 906a, the second transmission-reflection face 906b is disposed and/or positioned to intersect the optical path of emission light. The second transmission-reflection face 906b is also arranged to transmit the first and second components of emission light (as indicated by rays 902a and 902b), and to reflect a third component of emission light (as indicated by ray 902c). As in beamsplitter 900 described with respect to FIG. 9a, the first and second components of emission light are respectively transmitted through and reflected by the first transmission-reflection face 906a and pass to the first and second egress faces 909a, 909b, respectively, where they exit the beamsplitter 950. The reflected third component of emission light passes to a third egress face 909c, where the third component exits the beamsplitter 950. The third egress face 909c is perpendicular to the optical axis of the reflection from the second transmission-reflection face 906b. The third egress face 909c is optionally parallel to the second egress face 909b e.g. when the first and second transmission-reflectance faces 906a, 906b are arranged at 45 degrees to the ingress face and the ingress face is arranged perpendicular to the optical axis of converging beam from the tube lens at the ingress face.

As shown in FIG. 9b, the second transmission-reflection face 906b is angled obliquely with respect to the ingress face and optionally intersects the first transmission-reflection face. As an example, the second transmission-reflection face 906b of the depicted beamsplitter 950 is angled at 45° or substantially 45° with respect to the ingress face 904. However, the second transmission-reflection face 906b may be angled at any other oblique angle, such as between 20° and 80°, or between 30° and 60°. In embodiments where the second transmission-reflection face 906b intersects the first transmission-reflection face 906a, the first transmission-reflection face 906a is additionally arranged to transmit the third component of emission light (as indicated in FIG. 9b by ray 902c). The beamsplitter 950 of FIG. 9c is similar to the beamsplitter of FIG. 9a in that both beamsplitters 900, 960 include an ingress face 904, a first egress face 909a, a second egress face 909b, and a transmission-reflection face 906. These corresponding faces of FIG. 9a are as described with respect to FIG. 9a except for the following differences. The transmission-reflection face 906a of FIG. 9c is not angled at 45 degrees relative to the ingress face 904 as in FIG. 9a, but at less than 45 (e.g. 30) degrees relative to the ingress face 904. In addition, the second egress face 909b in FIG. 9c is not angled at 90 degrees relative to the ingress face 904 as in FIG. 9a but at more than 90 (e.g. 180−2×30=120) degrees relative to the ingress face 904. As described herein, the second egress face 909b is angled relative to the ingress face 904 so that the optical path length is independent of the azimuthal angle for rays travelling through the beamsplitter. Therefore, the astigmatism in the reflected beam 902b can be minimised. The arrangement of FIG. 9c can allow for a more compact design or a design allowing for alternative placement of the image sensors.

In each of FIGS. 9a, 9b and 9c, image sensors 908 are arranged to receive the respective beams emerging from the beamsplitter 400, 450, 460 at the normal angle to the plane of the image sensor 908. That is, the image sensors 908 are angled relative to the beamsplitter 400, 450, 460 so that representative (on-axis or central) rays 902a, 902b, 902c emerging from the egress faces 909a, 909b, 909c impinge on the respective image sensors 908 at 90 degrees to the plane of the image sensors 908.

In some embodiments, the beamsplitter 950 comprises four right-angled prisms affixed to one another and the first and second transmission-reflection faces 906a, 906b comprise the short (i.e., opposite and adjacent) sides of the right-angled prisms. Here, each right-angled prism is affixed to two other right-angled prisms at its respective short sides. The right-angled prisms are affixed to one another by any suitable means, such as by adhesive bonding or thermal bonding, as described with respect to the beamsplitter of FIG. 9a.

In some embodiments, the third component of emission light comprises a different wavelength to the first and second components. In some embodiments, the third component of emission light corresponds to emission from a third fluorophore in the sample and has a third wavelength different from the first and second wavelengths. In some embodiments, the first and second transmission-reflection faces 906a, 906b are respectively dichroic transmission-reflection faces. The first transmission-reflection face 906a is arranged to split the beam of light into two beams comprised of different wavelengths. The transmitted beam through the first transmission-reflection face 906a comprises the first and third wavelengths of the first and third components of emission light. The reflected beam from the first transmission-reflection face 906a comprises the second wavelength of the second component of emission light. Similarly, the transmitted beam through the second transmission-reflection face 906b comprises the first and second wavelength of the first and second components of emission light. The reflected beam through the second transmission-reflection face 906b comprises the third wavelength of the third component of emission light. As an example, each dichroic transmission-reflection face includes a dichroic mirror and/or dichroic reflector.

Each dichroic transmission-reflection face 906a, 906b of the beamsplitter 950 is manufactured by any suitable means, such as by coating the faces of the right-angle prisms forming each dichroic transmission-reflection face 906a, 906b with a suitable dichroic coating prior to affixing the right-angled prisms to one another. In some embodiments, the hypotenuse of each right-angled prism forms the ingress and egress faces and therefore is not coated. Instead, at least one short side of the right-angled prism forming the respective dichroic transmission-reflection face 906a, 906b is coated.

To illustrate the effect of the beamsplitters described herein, FIG. 10 shows a simplified view of a portion 500 of the imaging system 800 of FIG. 8. The simplified view includes the objective 802, tube lens 806, beamsplitter 804, first imaging sensor 808a and the contiguous beam path therethrough. Further, FIG. 10 depicts the first transmission channel through the beamsplitter 804 and to the first imaging sensor 808a, through which passes the first component of emission light. The second transmission channel (i.e. reflection channel) and second image sensor are not shown in FIG. 10.

The imaging system 800 takes any suitable parameters, in particular for numerical aperture (NA) and field of view (FOV). In some embodiments, the objective 802 has a NA between about 0.1 to about 1.4. In some instances, the NA is at least 0.1, at least 0.2, at least 0.3, at least 0.4, at least 0.5, at least 0.6, at least 0.7, at least 0.8, at least 0.9, at least 1.0, at least 1.1, at least 1.2, at least 1.3, or at least 1.4. In some instances, the NA is at most 1.4, at most 1.3, at most 1.2, at most 1.1, at most 1.0, at most 0.9, at most 0.8, at most 0.7, at most 0.6, at most 0.5, at most 0.4, at most 0.3, at most 0.2, or at most 0.1. In some embodiments, the objective 802 has a FOV between about 0.2 mm and 4 mm measured across the diagonal (or the diameter or longest dimension). In some instances, the FOV is at least 0.2 mm, at least 0.4 mm, at least 0.6 mm, at least 0.8 mm, at least 1.0 mm, at least 1.2 mm, at least 1.4 mm, at least 1.6 mm, at least 1.8 mm, at least 2.0 mm, at least 3.0 mm, or at least 4.0 mm measured across the diagonal (or the diameter or longest dimension). In some instances, the FOV is at most 4.0 mm, at most 3.0 mm, at most 2.0 mm, at most 1.8 mm, at most 1.6 mm, at most 1.4 mm, at most 1.0 mm, at most 0.8 mm, at most 0.6 mm, at most 0.4 mm, or at most 0.2 mm measured across the diagonal (or the diameter or longest dimension).

In some implementations, the NA is at least 0.8, about 0.8 to about 1.4, and/or about 1.0. In some implementations, the FOV is between 1.0 and 1.5 mm measured, optionally about 1.1 mm, measured across a diagonal. These values can realise a high magnification, low aperture imaging system according to the present disclosure. Such a high magnification, low aperture imaging system is particularly useful for imaging deep tissue stack samples, for example, a tissue sample having a thickness of about 5 microns to about 20 microns.

In one particular example, the objective 802 has magnification of ×20, NA of 1, working distance (WD) of 2 mm, objective field number of 22 mm, parfocalizing distance of 75 mm, and back focal plane (BFP) position of −48.1 mm.

Table 1 shows results of simulations using the ZEMAX® optical design program (ZEMAX Development Corporation) of astigmatism in the first transmission channel shown in FIG. 10 as the first component of emission light wavelengths vary. These simulations take NA as 1 and FOV as 1.1 mm. The exit pupil diameter is 4.1 mm. In these simulations, the root mean squared (RMS) astigmatism and the peak-to-valley astigmatism are measured substantially at the exit pupil.

TABLE 1

| Emission light | RMS astigmatism/ | Peak-to-valley astigmatism/ |
|---|---|---|
| wavelength/nm | waves | waves |
| 525 | 0.062 | 0.434 |
| 555 | 0.055 | 0.354 |
| 620 | 0.047 | 0.267 |
| 670 | 0.052 | 0.237 |

As shown, the RMS astigmatism introduced by the beamsplitter 804 across all wavelengths in Table 1 is below the diffraction limit of 0.075 RMS waves in this experimental example. Accordingly, the simulations confirm that the beamsplitter reduces astigmatism in the first transmission channel relative to the plate dichroic example of FIG. 7, particularly to below the diffraction limit and even below 0.07 RMS waves.

The simulation results in Table 1 include emission light of wavelength 525 nm, 555 nm, 620 nm and 670 nm. However, it is recognised that each component of emission light may take substantially any suitable wavelength. For instance, each component of emission light may comprise emission light with wavelength of any value from about 350 nm to about 900 nm, for example about 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, or 900 nm.

It has experimentally been shown that a beamsplitter according to the present disclosure introduces minimal aberration and astigmatism to the beam path depicted in FIG. 10 compared with a corresponding beam path without the beamsplitter. Table 2 shows test result data comparing the wavefront at the first image sensor in a system which includes the dichroic beamsplitter against a system which does not include any beamsplitter after the tube lens 806. The test result data is expressed in terms of coefficients for the first twelve Zernike polynomials. Zernike polynomials are used to express wavefront data in polynomial form and to identify wavefront aberration quantitatively. The test result data was taken at the position of the first image sensor 808a in the beam path depicted in FIG. 10 of an imaging system with an NA of 1 and a FOV of 1.1 mm. The dichroic beamsplitter used is as described with respect to FIG. 9a.

TABLE 2

| Degree of Zernike | Coefficient without | Coefficient with |
|---|---|---|
| polynomial | beamsplitter | beamsplitter |
| 1 | 0.052 | 0.055 |
| 2 | 0.000 | 0.000 |
| 3 | 0.010 | −0.018 |
| 4 | 0.002 | 0.000 |
| 5 | 0.000 | 0.000 |
| 6 | 0.014 | 0.023 |
| 7 | 0.001 | −0.008 |
| 8 | 0.000 | 0.000 |
| 9 | −0.043 | −0.044 |
| 10 | 0.000 | 0.000 |
| 11 | −0.019 | −0.020 |
| 12 | 0.013 | 0.013 |

As shown in Table 2, only the third and sixth Zernike polynomials' absolute values are notably affected by introduction of the dichroic beamsplitter. Specifically, the third Zernike polynomial increases in magnitude by 0.008 and the sixth Zernike polynomial increases by 0.009. The Zernike coefficients relate to an RMS wavefront error. Therefore, it can be seen that the increase in the third and sixth Zernike polynomials by 0.008 and 0.009 represents an increase in astigmatism of far below the diffraction limit of 0.075 RMS waves. The introduction of the dichroic beamsplitter does not therefore introduce any aberration above the diffraction limit.

In this experimental example, the axial chromatic shift introduced by the beamsplitter 900 is shown to be less than about 0.1 mm. For instance, the axial chromatic shift is less than about 0.1 mm for tangential rays. For wavelengths of 525 nm, 555 nm, and 620 nm the axial chromatic shift of tangential rays is shown to be less than about 0.05 mm. For wavelength of 670 nm the axial chromatic shift of tangential rays is shown to be less than 0.02 mm. For sagittal rays, the axial chromatic shift is shown to be of similar magnitude.

In the same experimental example, the field curvature is within a 0.35 mm depth of field for each colour channel. These examples correspond to an increase in field curvature due to the beamsplitter 804 of up to about 0.15 mm depth of field for each colour channel.

In the same experimental example, the total lateral chromatic shift is within about 4.0 μm. These examples correspond to an increase in lateral chromatic shift due to the beamsplitter 804 of up to about 1.5 μm. These values are well within the airy disk limit of just under 6.0 μm.

It has been shown experimentally that translating the beamsplitter 804 along the optical axis of the beam does not significantly affect aberration introduced by the beamsplitter, provided the beam is not clipped by a lateral edge of the beamsplitter 804. Therefore, the beamsplitter can be positioned at substantially any point along the optical axis of the beam between the tube lens and the first image sensor. To reduce the chance of beam path clipping, the clear aperture of the beamsplitter 804 ingress face can be equal to or larger than a clear aperture of the tube lens 806. In some implementations a distance 506 between the cube beamsplitter (e.g., the first egress face thereof) and the first sensor is about 10 mm to about 29 mm and/or the clear aperture of the beamsplitter (ingress face) is 22.5 mm. Translating the beamsplitter 804 across the axial direction of the beam path has also been shown not to introduce significant aberration provided that the beamsplitter does not clip the beam.

Simulations based on the experimental example described above have also shown that any astigmatism introduced by tilting the beamsplitter 804 is within the diffraction limit at alignments of less than about 5 degrees. For instance, a tilt 508 of +/−0.5 degrees is shown to only cause an RMS change of the order of 10⁻³ waves. Accordingly, in implementations, the tilt 508 of the beamsplitter 804 in the imaging system of FIG. 8 may be within 5 degrees, within 4 degrees, within 3 degrees, within 2 degrees, within 1 degree, or within 0.5 degrees. As shown in FIG. 10, the tilt 508 of the beamsplitter 804 is measured as the deviation of a normal of the ingress face from the optical axis of the converging beam from the tube lens 806.

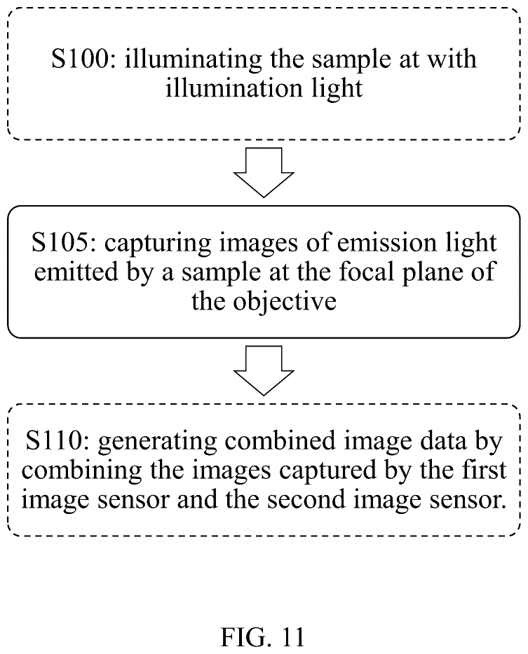

FIG. 11 shows an example method for imaging a sample. The method of FIG. 11 is carried out with any of the imaging systems described herein, particularly the imaging systems described with respect to FIGS. 8-10.

The method optionally begins at step S100 in which the sample is illuminated with illumination light. The sample is illuminated throughout the sample. In some embodiments, for instance in epifluorescence microscopes, the sample is illuminated by a light injection module, such as excitation light injection module 816 of FIG. 8. In some embodiments, the sample is illuminated by the illumination light in a transillumination configuration. In some embodiments, the illumination light is tuned (e.g., a maximization of the overlap between the illumination light spectrum given the absorption spectra of the particular fluorophore) to the fluorophore-dependent excitation wavelength or wavelengths of the fluorophores in the illuminated sample.

The method continues to, or starts instead at, step S105 in which images of emission light emitted by a sample at the focal plane of the objective are captured. The images are captured by first and second image sensors, such as the first and second image sensors of the imaging system of FIG. 8. Each sensor captures an image corresponding to a respective component of the emission light. Accordingly, a first image captured by a first sensor corresponds to a first component of the emission light emitted by a first fluorophore in the sample. Similarly, a second image captured by a second sensor corresponds to a second component of the emission light emitted by a second fluorophore in the sample.

The method optionally continues to step S110 in which combined image data is generated by combining the images captured by the first image sensor and the second image sensor. The combined image data is generated by at least one processor, such as a central processing unit, or the like, for example as part of the computer hardware described with reference to FIG. 5. As an example, the image data is combined by superimposition. Accordingly, the combined image data represents both components of emission light.

The at least one processor represents one or more general-purpose processors such as a microprocessor, central processing unit, or the like. More particularly, the processor may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor may also be one or more special-purpose processing devices such as an application specific integrated circuit (ASIC), a field programmable gate array (FPGA), a digital signal processor (DSP), network processor, or the like. The processor is configured to execute the processing logic for performing the operations, methods and steps discussed herein.

### General Terminology

Specific terminology is used throughout this disclosure to explain various aspects of the methods, systems, and compositions that are described. Unless otherwise defined, all of the technical terms used herein have the same meaning as commonly understood by one of ordinary skill in the art in the field to which this disclosure belongs.

It is to be understood that certain terminology is used in the preceding description for convenience and is not limiting. The terms “a”, “an” and “the” should be read as meaning “at least one” unless otherwise specified. The term “comprising” will be understood to mean “including but not limited to” such that systems or method comprising a particular feature or step are not limited to only those features or steps listed but may also comprise features or steps not listed. Similarly, any features included as examples are not to be construed as limiting to the disclosure. Additionally, any combination of features from one implementation with features from one or more other example(s) is to be understood as within the present disclosure. Equally, terms such as “after”, “before”, “in front”, “behind”, “downstream”, “upstream” and so on are used for convenience in interpreting the drawings and are not necessarily to be construed as limiting in absolute terms. Additionally, any method steps which are depicted in the figures as carried out sequentially, without causal connection, may alternatively be carried out in series in any order. Further, any method steps which are depicted as dashed or dotted flowchart boxes are to be understood as being optional.

As used herein, the term “amplitude” refers to a signed value (e.g., +1, −1, +0.1, −0.1, +0.01, −0.01, etc.) representing direction of movement of a pixel in an image. In a first example, the amplitude indicates a direction of movement (e.g., towards an attraction basin) using single, discrete values for a positive direction, a negative direction, and no movement along a given dimension (e.g., x-dimension, y-dimension, and/or z-dimension). In some embodiments, the amplitude is a whole integer selected from a set of {−1, 0, +1} that indicates a direction of motion. In this case, a positive 1 indicates motion in a first direction (e.g., up/+y) along the given dimension (e.g., the vertical dimension/y). A negative value of the amplitude indicates motion in a second, opposite, direction (e.g., down/−y) along the given dimension (e.g., the vertical dimension/y). A zero value indicates no motion in the given dimension. In other embodiments, the amplitude is a signed probability value. In particular, an amplitude on the interval [−1,1] is provided corresponding to a given dimension (e.g., x-dimension, y-dimension, or z-dimension) of an image. In this case, a positive value of the amplitude indicates the probability of movement in a first direction (e.g., up/+y) along the given dimension (e.g., the vertical dimension/y). A negative value of the amplitude indicates the probability of movement in a second, opposite, direction (e.g., down/−y) along the given dimension (e.g., the vertical dimension/y). A zero value indicates no motion in the given dimension. The magnitude of an amplitude refers to the absolute value of the amplitude, that is the magnitude is without direction. For ease of reference, a pixel having a zero amplitude or an amplitude of low magnitude (i.e., below a given threshold) is referred to as stationary. A pixel having magnitude exceeding that threshold are referred to as moving.

As used herein, the term “flow” as applied to pixels refers to the piecewise path from a pixel through zero or more intermediate pixels to a basin conforming to the amplitudes of those pixels. For example, a pixel that is adjacent to a basin pixel and has an amplitude indicating movement towards the basin pixel has length one flow to the basin. A piecewise path may be constructed from pixel to pixel according to the movement indicated by each pixel's amplitude until arrival at a basin.

With reference to pixels of an image, adjacent pixels are those that share an edge or a corner.

As used in this specification and the appended claims, the singular forms “a”, “an”, and “the” include plural references unless the context clearly dictates otherwise. For example, “a” or “an” means “at least one” or “one or more”. Any reference to “or” herein is intended to encompass “and/or” unless otherwise stated.

As used herein, the terms “comprising” (and any form or variant of comprising, such as “comprise” and “comprises”), “having” (and any form or variant of having, such as “have” and “has”), “including” (and any form or variant of including, such as “includes” and “include”), or “containing” (and any form or variant of containing, such as “contains” and “contain”), are inclusive or open-ended and do not exclude additional, un-recited additives, components, integers, elements or method steps.

As used herein, the term “about” a number refers to that number plus or minus 10% of that number. The term ‘about’ when used in the context of a range refers to that range minus 10% of its lowest value and plus 10% of its greatest value.

Throughout this disclosure, various aspects of the claimed subject matter are presented in a range format. It should be understood that the description in range format is merely for convenience and brevity and should not be construed as an inflexible limitation on the scope of the claimed subject matter. Accordingly, the description of a range should be considered to have specifically disclosed all the possible sub-ranges as well as individual numerical values within that range. For example, where a range of values is provided, it is understood that each intervening value, between the upper and lower limit of that range and any other stated or intervening value in that stated range is encompassed within the claimed subject matter. The upper and lower limits of these smaller ranges may independently be included in the smaller ranges, and are also encompassed within the claimed subject matter, subject to any specifically excluded limit in the stated range. Where the stated range includes one or both of the limits, ranges excluding either or both of those included limits are also included in the claimed subject matter. This applies regardless of the breadth of the range.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Similarly, use of a), b), etc., or i), ii), etc. does not by itself connote any priority, precedence, or order of steps in the claims. Similarly, the use of these terms in the specification does not by itself connote any required priority, precedence, or order.

The term “platform” (or “system”) may refer to an ensemble of: (i) instruments (e.g., imaging instruments, fluid controllers, temperature controllers, motion controllers and translation stages, etc.), (ii) devices (e.g., specimen slides, substrates, flow cells, microfluidic devices, etc., which may comprise fixed and/or removable or disposable components of the platform), (iii) reagents and/or reagent kits, and (iv) software, or any combination thereof, which allows a user to perform one or more bioassay methods (e.g., analyte detection, in situ detection or sequencing, and/or nucleic acid detection or sequencing) depending on the particular combination of instruments, devices, reagents, reagent kits, and/or software utilized.

The section headings used herein are for organizational purposes only and are not to be construed as limiting the subject matter described.

### Barcoding and Decoding Terminology

A “barcode” is a label, or identifier, that conveys or is capable of conveying information (e.g., information about an analyte in a sample, a cell, a bead, a location, a sample, and/or a capture probe). The term “barcode” may refer either to a physical barcode molecule (e.g., a nucleic acid barcode molecule) or to its representation in a computer-readable, digital format (e.g., as a string of characters representing the sequence of bases in a nucleic acid barcode molecule).

The phrase “barcode diversity” refers to the total number of unique barcode sequences that may be represented by a given set of barcodes.

A physical barcode molecule (e.g., a nucleic acid barcode molecule) that forms a label or identifier as described above. In some instances, a barcode can be part of an analyte, can be independent of an analyte, can be attached to an analyte, or can be attached to or part of a probe that targets the analyte. In some instances, a particular barcode can be unique relative to other barcodes.

Physical barcodes can have a variety of different formats. For example, barcodes can include polynucleotide barcodes, random nucleic acid and/or amino acid sequences, and synthetic nucleic acid and/or amino acid sequences. A physical barcode can be attached to an analyte, or to another moiety or structure, in a reversible or irreversible manner. A physical barcode can be added to, for example, a fragment of a deoxyribonucleic acid (DNA) or ribonucleic acid (RNA) sample before or during sequencing of the sample. In some instances, barcodes can allow for identification and/or quantification of individual sequencing-reads in sequencing-based methods (e.g., a barcode can be or can include a unique molecular identifier or “UMI”). Barcodes can be used to detect and spatially-resolve molecular components found in biological samples, for example, at single-cell resolution (e.g., a barcode can be, or can include, a molecular barcode, a spatial barcode, a unique molecular identifier (UMI), etc.).

In some instances, barcodes may comprise a series of two or more segments or sub-barcodes (e.g., corresponding to “letters” or “code words” in a decoded barcode), each of which may comprise one or more of the subunits or building blocks used to synthesize the physical (e.g., nucleic acid) barcode molecules. For example, a nucleic acid barcode molecule may comprise two or more barcode segments, each of which comprises one or more nucleotides. In some instances, a barcode may comprise at least 1, 2, 3, 4, 5, 6, 7, 8, 9, 10, or more than 10 segments. In some instances, each segment of a barcode molecule may comprise at least 1, 2, 3, 4, 5, 6, 7, 8, 9, 10, 12, 14, 16, 18, 20, or more than 20 subunits or building blocks. For example, each segment of a nucleic acid barcode molecule may comprise at least 1, 2, 3, 4, 5, 6, 7, 8, 9, 10, 12, 14, 16, 18, 20, or more than 20 nucleotides. In some instances, two or more of the segments of a barcode may be separated by non-barcode segments, i.e., the segments of a barcode molecule need not be contiguous.

A “digital barcode” (or “digital barcode sequence”) is a representation of a corresponding physical barcode (or target analyte sequence) in a computer-readable, digital format as described above. A digital barcode may comprise one or more “letters” (e.g., 1, 2, 3, 4, 5, 6, 7, 8, 9, 10, 12, 14, 16, 18, 20, or more than 20 letters) or one or more “code words” (e.g., 1, 2, 3, 4, 5, 6, 7, 8, 9, 10, or more than 10 code words), where a “code word” comprises, e.g., 1, 2, 3, 4, 5, 6, 7, 8, 9, 10, 12, 14, 16, 18, 20, or more than 20 letters. In some instances, the sequence of letters or code words in a digital barcode sequence may correspond directly with the sequence of building blocks (e.g., nucleotides) in a physical barcode. In some instances, the sequence of letters or code words in a digital barcode sequence may not correspond directly with the sequence of building blocks in a physical barcode, but rather may comprise, e.g., arbitrary code words that each correspond to a segment of a physical barcode. For example, in some instances, the disclosed methods for decoding and error correction may be applied directly to detecting target analyte sequences (e.g., mRNA sequences) as opposed to detecting target barcodes, and the barcode probes used to detect the target analyte sequences may correspond to letters or code words that have been assigned to specific target analyte sequences but that do not directly correspond to the target analyte sequences.

A “designed barcode” (or “designed barcode sequence”) is a barcode (or its digital equivalent: in some instances a designed barcode may comprise a series of code words that can be assigned to gene transcripts and subsequently decoded into a decoded barcode) that meets a specified set of design criteria as required for a specific application. In some instances, a set of designed barcodes may comprise at least 2, at least 5, at least 10, at least 20, at least 40, at least 60, at least 80, at least 100, at least 200, at least 400, at least 600, at least 800, at least 1,000, at least 2,000, at least 4,000, at least 6,000, at least 8,000, at least 10,000, at least 20,000, at least 40,000, at least 60,000, at least 80,000, at least 100,000, at least 200,000, at least 400,000, at least 600,000, at least 800,000, at least 1,000,000, at least 2×10⁶, at least 3×10⁶, at least 4×10⁶, at least 5×10⁶, at least 6×10⁶, at least 7×10⁶, at least 8×10⁶, at least 9×10⁶, at least 10⁷, at least 10⁸, at least 10⁹, or more than 10⁹ unique barcodes. In some instances, a set of designed barcodes may comprise any number of designed barcodes within the range of values in this paragraph, e.g., 1,225 unique barcodes or 2.38×10⁶ unique barcodes. As noted above for barcodes in general, in some instances designed barcodes may comprise two or more segments (corresponding to two or more code words in a decode barcode). In those cases, the specified set of design criteria may be applied to the designed barcodes as a whole, or to one or more segments (or positions) within the designed barcodes.

A “decoded barcode” (or “decoded barcode sequence”) is a digital barcode sequence generated via a decoding process that ideally matches a designed barcode sequence, but that may include errors arising from noise in the synthesis process used to create barcodes and/or noise in the decoding process itself. As noted above, in some instances, the disclosed methods for decoding and error correction may be applied directly to detecting target analytes (e.g., mRNA sequences) as opposed to detecting target barcodes, and the barcode probes used to detect the target analytes may correspond to letters or code words that have been assigned to specific target analytes but that do not directly correspond to the target analytes. In these instances, a decoded barcode (i.e., a series of letters or code words) may serve as a proxy for the target analyte.

A “corrected barcode” (or “corrected barcode sequence”) is a digital barcode sequence derived from a decoded barcode sequence by applying one or more error correction methods.

### Probe Terminology

The term “probe” may refer either to a physical probe molecule (e.g., a nucleic acid probe molecule) or to its representation in a computer-readable, digital format (e.g., as a string of characters representing the sequence of bases in a nucleic acid probe molecule). A “probe” may be, for example, a molecule designed to recognize (and bind or hybridize to) another molecule, e.g., a target analyte, another probe molecule, etc.

In some instances, a physical probe molecule may comprise one or more of the following: (i) a target recognition element (e.g., an antibody capable of recognizing and binding to a target peptide, protein, or small molecule; an oligonucleotide sequence that is complementary to a target gene sequence or gene transcript; or a poly-T oligonucleotide sequence that is complementary to the poly-A tails on messenger RNA molecules), (ii) a barcode element (e.g., a molecular barcode, a cell barcode, a spatial barcode, and/or a unique molecular identifier (UMI)), (iii) an amplification and/or sequencing primer binding site, (iv) one or more linker regions, (v) one or more detectable tags (e.g., fluorophores), or any combination thereof. In some instances, each component of a probe molecule may comprise at least 1, 2, 3, 4, 5, 6, 7, 8, 9, 10, 12, 14, 16, 18, 20, or more than 20 subunits or building blocks. For example, in some instances, each component of a nucleic acid probe molecule may comprise at least 1, 2, 3, 4, 5, 6, 7, 8, 9, 10, 12, 14, 16, 18, 20, or more than 20 nucleotides.

In some instances, physical probes may bind or hybridize directly to their target. In some instances, physical probes may bind or hybridize indirectly to their target. For example, in some instances, a secondary probe may bind or hybridize to a primary probe, where the primary probe binds or hybridizes directly to the target analyte. In some instances, a tertiary probe may bind or hybridize to a secondary probe, where the secondary probe binds or hybridizes to a primary probe, and where the primary probe binds or hybridizes directly to the target analyte.

Examples of “probes” and their applications include, but are not limited to, primary probes (e.g., molecules designed to recognize and bind or hybridize to target analyte), intermediate probes (e.g., molecules designed to recognize and bind or hybridize to another molecule and provide a hybridization or binding site for another probe (e.g., a detection probe), detection probes (e.g., molecules designed to recognize and bind or hybridize to another molecule, detection probes may be labeled with a fluorophore or other detectable tag). In some instances, a probe may be designed to recognize and bind (or hybridize) to a physical barcode sequence (or segments thereof). In some instances, a probe may be used to detect and decode a barcode, e.g., a nucleic acid barcode. In some instances, a probe may bind or hybridize directly to a target barcode. In some instances, a probe may bind or hybridize indirectly to a target barcode (e.g., by binding or hybridizing to other probe molecules which itself is bound or hybridized to the target barcode).

### Nucleic Acid Molecule and Nucleotide Terminology

The terms “nucleic acid” (or “nucleic acid molecule”) and “nucleotide” are intended to be consistent with their use in the art and to include naturally-occurring species or functional analogs thereof. Particularly useful functional analogs of nucleic acids are capable of hybridizing to a nucleic acid in a sequence-specific fashion (e.g., capable of hybridizing to two nucleic acids such that ligation can occur between the two hybridized nucleic acids) or are capable of being used as a template for replication of a particular nucleotide sequence. Naturally-occurring nucleic acids generally have a backbone containing phosphodiester bonds. An analog structure can have an alternate backbone linkage including any of a variety of those known in the art. Naturally-occurring nucleic acids generally have a deoxyribose sugar (e.g., found in deoxyribonucleic acid (DNA)) or a ribose sugar (e.g. found in ribonucleic acid (RNA)).

A nucleic acid can contain nucleotides having any of a variety of analogs of these sugar moieties that are known in the art. A nucleic acid can include natural or non-natural nucleotides. In this regard, a naturally-occurring deoxyribonucleic acid can have one or more bases selected from the group consisting of adenine (A), thymine (T), cytosine (C), or guanine (G), and a ribonucleic acid can have one or more bases selected from the group consisting of uracil (U), adenine (A), cytosine (C), or guanine (G). Useful non-natural bases that can be included in a nucleic acid or nucleotide are known in the art. See, for example, Appella (2009), “Non-Natural Nucleic Acids for Synthetic Biology”, Curr Opin Chem Biol. 13 (5-6): 687-696; and Duffy, et al. (2020), “Modified Nucleic Acids: Replication, Evolution, and Next-Generation Therapeutics”, BMC Biology 18:112.

### Samples:

A sample disclosed herein can be or derived from any biological sample. Methods and compositions disclosed herein may be used for analyzing a biological sample, which may be obtained from a subject using any of a variety of techniques including, but not limited to, biopsy, surgery, and laser capture microscopy (LCM), and generally includes cells and/or other biological material from the subject. In addition to the subjects described above, a biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample, a patient derived organoid (PDO) or patient derived xenograft (PDX). A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic individuals, individuals that have or are suspected of having a disease (e.g., a patient with a disease such as cancer) or a pre-disposition to a disease, and/or individuals in need of therapy or suspected of needing therapy.

The biological sample can include any number of macromolecules, for example, cellular macromolecules and organelles (e.g., mitochondria and nuclei). The biological sample can be a nucleic acid sample and/or protein sample. The biological sample can be a carbohydrate sample or a lipid sample. The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions. In some instances, the biological sample may comprise cells which are deposited on a surface.

Cell-free biological samples can include extracellular macromolecules, e.g., polynucleotides. Extracellular polynucleotides can be isolated from a bodily sample, e.g., blood, plasma, serum, urine, saliva, mucosal excretions, sputum, stool, and tears.

Biological samples can be derived from a homogeneous culture or population of the subjects or organisms mentioned herein or alternatively from a collection of several different organisms, for example, in a community or ecosystem.

Biological samples can include one or more diseased cells. A diseased cell can have altered metabolic properties, gene expression, protein expression, and/or morphologic features. Examples of diseases include inflammatory disorders, metabolic disorders, nervous system disorders, and cancer. Cancer cells can be derived from solid tumors, hematological malignancies, cell lines, or obtained as circulating tumor cells. Biological samples can also include fetal cells and immune cells.

In some instances, a substrate herein can be any support that is insoluble in aqueous liquid and which allows for positioning of biological samples, analytes, features, and/or reagents (e.g., probes) on the support. In some instances, a biological sample can be attached to a substrate. Attachment of the biological sample can be irreversible or reversible, depending upon the nature of the sample and subsequent steps in the analytical method. In certain instances, the sample can be attached to the substrate reversibly by applying a suitable polymer coating to the substrate, and contacting the sample to the polymer coating. The sample can then be detached from the substrate, e.g., using an organic solvent that at least partially dissolves the polymer coating. In some instances, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

A variety of steps can be performed to prepare or process a biological sample for and/or during an assay. Except where indicated otherwise, the preparative or processing steps described below can generally be combined in any manner and in any order to appropriately prepare or process a particular sample for and/or analysis.

### Endogenous Analytes:

In some instances, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that comprises a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments. In some instances, the analyte is inside a cell or on a cell surface, such as a transmembrane analyte or one that is attached to the cell membrane. In some instances, the analyte can be an organelle (e.g., nuclei or mitochondria). In some instances, the analyte is an extracellular analyte, such as a secreted analyte. Exemplary analytes include, but are not limited to, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, an extracellular matrix protein, a posttranslational modification (e.g., phosphorylation, glycosylation, ubiquitination, nitrosylation, methylation, acetylation or lipidation) state of a cell surface protein, a gap junction, and an adherens junction.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR. The RNA can be small (e.g., less than 200 nucleic acid bases in length) or large (e.g., RNA greater than 200 nucleic acid bases in length). Examples of small RNAs include 5.8S ribosomal RNA (rRNA), 5S rRNA, tRNA, miRNA, siRNA, snoRNAs, piRNA, tRNA-derived small RNA (tsRNA), and small rDNA-derived RNA (srRNA). The RNA can be double-stranded RNA or single-stranded RNA. The RNA can be circular RNA. The RNA can be a bacterial rRNA (e.g., 16s rRNA or 23s rRNA).

In some instances described herein, an analyte may be a denatured nucleic acid, wherein the resulting denatured nucleic acid is single-stranded. The nucleic acid may be denatured, for example, optionally using formamide, heat, or both formamide and heat. In some instances, the nucleic acid is not denatured for use in a method disclosed herein.

In certain instances, an analyte can be extracted from a live cell. Processing conditions can be adjusted to ensure that a biological sample remains live during analysis, and analytes are extracted from (or released from) live cells of the sample. Live cell-derived analytes can be obtained only once from the sample, or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any implementation described herein, the analyte comprises a target sequence. In some instances, the target sequence may be endogenous to the sample, generated in the sample, added to the sample, or associated with an analyte in the sample. In some instances, the target sequence is a single-stranded target sequence (e.g., a sequence in a rolling circle amplification product). In some instances, the analytes comprise one or more single-stranded target sequences. In one aspect, a first single-stranded target sequence is not identical to a second single-stranded target sequence. In another aspect, a first single-stranded target sequence is identical to one or more second single-stranded target sequence. In some instances, the one or more second single-stranded target sequence is comprised in the same analyte (e.g., nucleic acid) as the first single-stranded target sequence. Alternatively, the one or more second single-stranded target sequence is comprised in a different analyte (e.g., nucleic acid) from the first single-stranded target sequence.

### Labelling Agents:

In some instances, provided herein are methods and compositions for analyzing endogenous analytes (e.g., RNA, ssDNA, and cell surface or intracellular proteins and/or metabolites) in a sample using one or more labelling agents. In some instances, an analyte labelling agent may include an agent that interacts with an analyte (e.g., an endogenous analyte in a sample). In some instances, the labelling agents can comprise a reporter oligonucleotide that is indicative of the analyte or portion thereof interacting with the labelling agent. For example, the reporter oligonucleotide may comprise a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some instances, the analyte labelling agent comprises an analyte binding moiety and a labelling agent barcode domain comprising one or more barcode sequences, e.g., a barcode sequence that corresponds to the analyte binding moiety and/or the analyte. An analyte binding moiety barcode includes to a barcode that is associated with or otherwise identifies the analyte binding moiety. In some instances, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some instances, the method comprises one or more post-fixing (also referred to as post-fixation) steps after contacting the sample with one or more labelling agents.

In the methods and systems described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some instances, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may comprise a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto.

Accordingly, terms such as “stain”, “staining”, “labeling”, and the like, may be used interchangeably to refer to elements, complexes, and macromolecules that allow a substance, structure, organelle, and/or component in a sample to be more easily detected than if said substance, structure, organelle, and/or component had not been stained or stained. For example, a tissue sample treated with a DNA dye such as DAPI (4′,6-diamidino-2-phenylindole) makes the nucleus of a cell more visible and makes detection or quantification of such cells easier than if they were not stained. Without being bound by theory or methodology, the labeling described herein may be used to mark a cell, structure, particle, or other target, and may be useful in discovering, determining expression, localization, confirmation, quantification, or measuring properties within a sample. Without limitation, labeling agents disclosed herein include stains, dyes, ligands, antibodies, particles, and other substances that may bind to or be localized at certain specific objects or locations. “Labels” or “labeling agents” may also refer to compounds or compositions which are conjugated or fused directly or indirectly to a reagent such as an oligonucleotide as disclosed herein or an antibody, and facilitates detection of the reagent to which it is conjugated or fused. The label may itself be detectable (e.g., radioisotope labels or fluorescent labels) or may catalyze chemical alteration of a substrate compound or composition which is detectable, e.g., an enzymatic label.

As provided by the invention disclosed herein, one or more features are derived by detecting nuclei, cell membrane, and/or cytoplasm of cells within the input image and/or by extracting features from the detected nuclei, cell membrane, and/or cytoplasm (depending upon the labeling agent(s) utilized within the input image). In some embodiments, features are derived by analyzing cell membrane staining, cell cytoplasm staining, and/or cell nucleus staining. Without being bound by theory or methodology “cytoplasmic staining” may describe a group of pixels arranged in a pattern bearing the morphological characteristics of a cytoplasmic region of a cell. Similarly “membrane staining” may refer to a group of pixels arranged in a pattern bearing the morphological characteristics of a cell membrane, preferably the plasma membrane separating the intracellular environment from the extracellular space; and “nucleus staining” may refer to a group of pixels with strong localized intensity in a pattern bearing the morphological characteristics of a nucleus of the cell. Those of skill in the art will appreciate that the nucleus, cytoplasm, and membrane of a cell have different characteristics and that differently stained tissue samples may reveal different biological features. For example, those of skill would understand that certain cell surface elements and receptors can have staining patterns localized to the membrane or localized to the cytoplasm. Thus, a “membrane” staining pattern may be analytically distinct from a “cytoplasmic” staining pattern. Likewise, a “cytoplasmic” staining pattern and a “nuclear” staining pattern may be analytically distinct.

In some such embodiments, labels or labelling comprises tissue and/or cell surface staining. Surface stains may include general lipid stains, fluorescent lipid analogues, sugar-binding lectins, label-conjugated protein-specific antibodies, and plasma membrane-specific dyes, stains, and label-conjugated antibodies. Those of skill in the art will appreciate and understand that a biological sample may be stained for different types of and/or cell membrane structures/components. Stains and dyes that label cell nuclei may include hematoxylin dyes, cyanine dyes, Draq dyes, and DAPI stain. Stains and dyes that label the cytoplasm of cells may include eosin dyes, fluorescein dyes, and the like. Alternatively, binding moieties (e.g., ligands, antibodies, and or peptides) directed/localizing to a cell membrane (e.g., the plasma membrane), the cytoplasm, the nucleus, or other structure/organelle of the cell may be conjugated to a labeling moiety described herein, thereby providing a detectable signal that identifies said membrane, cytoplasm, and/or nucleus. Such labeling can be used individually or in combination to aid in visualization, identification, and quantification of cells.

In some embodiments of the invention, the labelling described herein may be cell specific (e.g., cell-type specific), thus providing the detection of different cell types within a sample. In some embodiments, the invention disclosed herein, or elements thereof, incorporate identification of cell polarity and/or morphology. Cell polarity may refer to an asymmetry in molecular composition or structure between two sides, thus defining a polarity axis along which cellular processes will be differentially regulated. In some such embodiments, the invention incorporates identifying cellular symmetry, including the distribution of structures and/or organelles within the cells. For example and without limitation, the radial symmetry of labeled structures or organelles relative to other stains, e.g., plasma membrane, cytoplasmic and/or nuclear labels, such as the radial staining pattern of cytoskeletal structures or mitochondria relative to nuclear, cytoplasmic, and/or plasma membrane stains/labels in fibroblastic cell types. Similarly, the polarization of structures or organelles relative to other stains, e.g., plasma membrane, cytoplasmic and/or nuclear stains/labels, such as those polarized structures observed in the axonal projections of neuronal cells or the apical/basal polarity of epithelial cells.

Exemplary methods for staining tissue structures and guidance in the choice of stains appropriate for various purposes are known in the art and are discussed, for example, in “Sambrook et al., Molecular Cloning: A Laboratory Manual, Cold Spring Harbor Laboratory Press (1989)” and “Ausubel et al., Current Protocols in Molecular Biology, Greene Publishing Associates and Wiley-Intersciences (1987),” the disclosures of which are incorporated herein by reference. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some instances, an analyte binding moiety includes one or more antibodies or antigen binding fragments thereof. The antibodies or antigen binding fragments including the analyte binding moiety can specifically bind to a target analyte. In some instances, the analyte is a protein (e.g., a protein on a surface of the biological sample (e.g., a cell) or an intracellular protein). In some instances, a plurality of analyte labelling agents comprising a plurality of analyte binding moieties bind a plurality of analytes present in a biological sample. In some instances, the plurality of analytes includes a single species of analyte (e.g., a single species of polypeptide). In some instances in which the plurality of analytes includes a single species of analyte, the analyte binding moieties of the plurality of analyte labelling agents are the same. In some instances in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some instances, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may comprise nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31 (2): 708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide comprising a barcode sequence that identifies the label agent. For instance, the labelling agent may be directly coupled (e.g., covalently bound) to a hybridization oligonucleotide that comprises a sequence that hybridizes with a sequence of the reporter oligonucleotide. Hybridization of the hybridization oligonucleotide to the reporter oligonucleotide couples the labelling agent to the reporter oligonucleotide. In some instances, the reporter oligonucleotides are releasable from the labelling agent, such as upon application of a stimulus. For example, the reporter oligonucleotide may be attached to the labelling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can comprise a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some instances, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent comprising an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

### Assays for In Situ Detection and Analysis:

Objectives for in situ detection and analysis methods include detecting, quantifying, and/or mapping analytes (e.g., gene activity) to specific regions in a biological sample (e.g., a tissue sample or cells deposited on a surface) at cellular or sub-cellular resolution. Methods for performing in situ studies include a variety of techniques, e.g., in situ hybridization and in situ sequencing techniques. These techniques allow one to study the subcellular distribution of target analytes (e.g., gene activity as evidenced, e.g., by expressed gene transcripts), and have the potential to provide crucial insights in the fields of developmental biology, oncology, immunology, histology, etc.

Various methods can be used for in situ detection and analysis of target analytes, e.g., sequencing by synthesis (SBS), sequencing by ligation (SBL), sequencing by hybridization (SBH). Non-limiting examples of in situ hybridization techniques include single molecule fluorescence in situ hybridization (smFISH) and multiplexed error-robust fluorescence in situ hybridization (MERFISH). smFISH enables in situ detection and quantification of gene transcripts in tissue samples at the locations where they reside by making use of libraries of multiple short oligonucleotide probes (e.g., approximately 20 base pairs (bp) in length), each labeled with a fluorophore. The probes are sequentially hybridized to gene sequences (e.g., DNA) or gene transcript sequences (e.g., mRNA) sequences, and visualized as diffraction-limited spots by fluorescence microscopy (Levsky, et al. (2003) “Fluorescence In situ Hybridization: Past, Present and Future”, Journal of Cell Science 116 (14): 2833-2838; Raj, et al. (2008) “Imaging Individual mRNA Molecules Using Multiple Singly Labeled Probes”, Nat Methods 5 (10): 877-879; Moor, et al. (2016), ibid.). Variations on the smFISH method include, for example, the use of combinatorial labelling schemes to improve multiplexing capability (Levsky, et al. (2003), ibid.), the use of smFISH in combination with super-resolution microscopy (Lubeck, et al. (2014) “Single-Cell In situ RNA Profiling by Sequential Hybridization”, Nature Methods 11 (4): 360-361).

MERFISH addresses two of the limitations of earlier in situ hybridization approaches, namely the limited number of target sequences that could be simultaneously identified and the robustness of the approach to readout errors caused by the stochastic nature of the hybridization process (Moor, et al. (2016), ibid.). MERFISH utilizes a binary barcoding scheme in which the probed target mRNA sequences are either fluorescence positive or fluorescence negative for any given imaging cycle (Ke, et al. (2016), ibid.; Moffitt, et al. (2016) “RNA Imaging with Multiplexed Error Robust Fluorescence In situ Hybridization”, Methods Enzymol. 572:1-49). The encoding probes that contain a combination of target-specific hybridization sequence regions and barcoded readout sequence regions are first hybridized to the target mRNA sequences. In each imaging cycle, a subset of fluorophore-conjugated readout probes is hybridized to a subset of encoding probes. Target mRNA sequences that fluoresce in a given cycle are assigned a value of “1” and the remaining target mRNA sequences are assigned a value of “0”. Between imaging cycles, the fluorescent probes from the previous cycle are photobleached. After, e.g., 14 or 16 rounds of readout probe hybridization and imaging, unique combinations of the detected fluorescence signals generate a 14-bit or 16-bit code that identifies the different gene transcripts. To address the increased error rate for correctly calling the readout codes increases as the number of hybridization and imaging cycles increases, the method may also entail the use of Hamming distances for barcode design and correction of decoding errors (see., e.g., Buschmann, et al. (2013) “Levenshtein Error-Correcting Barcodes for Multiplexed DNA Sequencing”, Bioinformatics 14:272), thereby resulting in an error-robust barcoding scheme.

Some in situ sequencing techniques generally comprise both in situ target capture (e.g., of mRNA sequences) and in situ sequencing. Non-limiting examples of in situ sequencing techniques include in situ sequencing with padlock probes (ISS-PLP), fluorescent in situ sequencing (FISSEQ), barcode in situ targeted sequencing (Barista-Seq), and spatially-resolved transcript amplicon readout mapping (STARmap) (see, e.g., Ke, et al. (2016), ibid., Asp, et al. (2020), ibid.).

Some methods for in situ detection and analysis of analytes utilize a probe (e.g., padlock or circular probe) that detects specific target analytes. The in situ sequencing using padlock probes (ISS-PLP) method, for example, combines padlock probing to target specific gene transcripts, rolling-circle amplification (RCA), and sequencing by ligation (SBL) chemistry. Within intact tissue sections, reverse transcription primers are hybridized to target sequence (e.g., mRNA sequences) and reverse transcription is performed to create cDNA to which a padlock probe (a single-stranded DNA molecule comprising regions that are complementary to the target cDNA) can bind (see, e.g., Asp, et al. (2020), ibid.). In one variation of the method, the padlock probe binds to the cDNA target with a gap remaining between the ends which is then filled in using a DNA polymerization reaction. In another variation of the method, the ends of the bound padlock probe are adjacent to each other. The ends are then ligated to create a circular DNA molecule. Target amplification using rolling-circle amplification (RCA) results in micrometer-sized RCA products (RCPs), containing a plurality of concatenated repeats of the probe sequence. In some examples, RCPs are then subjected to, e.g., sequencing-by-ligation (SBL) or sequencing-by-hybridization (SBH). In some cases, the method allows for a barcode located within the probe to be decoded.

Products of Endogenous Analytes and/or Labelling Agents:

In some instances, provided herein are methods and compositions for analyzing one or more products of an endogenous analyte and/or a labelling agent in a biological sample. In some instances, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product such as a rolling circle amplification (RCA) product) thereof is analyzed. In some instances, a labelling agent that directly or indirectly binds to an analyte in the biological sample is analyzed. In some instances, a product (e.g., a hybridization product, a ligation product, an extension product (e.g., by a DNA or RNA polymerase), a replication product, a transcription/reverse transcription product, and/or an amplification product such as a rolling circle amplification (RCA) product) of a labelling agent that directly or indirectly binds to an analyte in the biological sample is analyzed.

In some instances, the analyzing comprises using primary probes which comprise a target binding region (e.g., a region that binds to a target such as RNA transcripts) and the primary probes may contain one or more barcodes (e.g., primary barcode). In some instances, the barcodes are bound by detection primary probes, which do not need to be fluorescent, but that include a target-binding portion (e.g., for hybridizing to one or more primary probes) and one or more barcodes (e.g., secondary barcodes). In some instances, the detection primary probe comprises an overhang that does not hybridize to the target nucleic acid but hybridizes to another probe. In some examples, the overhang comprises the barcode(s). In some instances, the barcodes of the detection primary probes are targeted by detectably labeled detection oligonucleotides, such as fluorescently labeled oligos. In some instances, one or more decoding schemes are used to decode the signals, such as fluorescence, for sequence determination. Various probes and probe sets can be used to hybridize to and detect an endogenous analyte and/or a sequence associated with a labelling agent. In some instances, these assays may enable multiplexed detection, signal amplification, combinatorial decoding, and error correction schemes. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set. The specific probe or probe set design can vary.

### Hybridization and Ligation:

Various probes and probe sets can be hybridized to an endogenous analyte and/or a labelling agent and each probe may comprise one or more barcode sequences. The specific probe or probe set design can vary. In some instances, the hybridization of a primary probe or probe set (e.g., a circularizable probe or probe set) to a target nucleic acid analyte and may lead to the generation of a rolling circle amplification (RCA) template. In some instances, the assay uses or generates a circular nucleic acid molecule which can be the RCA template.

In some instances, a product of an endogenous analyte and/or a labelling agent is a ligation product. In some instances, the ligation product is formed from circularization of a circularizable probe or probe set upon hybridization to a target sequence. In some instances, the ligation product is formed between two or more endogenous analytes. In some instances, the ligation product is formed between an endogenous analyte and a labelling agent. In some instances, the ligation product is formed between two or more labelling agent. In some instances, the ligation product is an intramolecular ligation of an endogenous analyte. In some instances, the ligation product is an intramolecular ligation of a labelling agent, for example, the circularization of a circularizable probe or probe set upon hybridization to a target sequence. The target sequence can be comprised in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some instances, provided herein is a probe or probe set capable of DNA-templated ligation, such as from a cDNA molecule. See, e.g., U.S. Pat. No. 8,551,710, which is hereby incorporated by reference in its entirety. In some instances, provided herein is a probe or probe set capable of RNA-templated ligation. See, e.g., U.S. Pat. Pub. 2020/0224244 which is hereby incorporated by reference in its entirety. In some instances, the probe set is a SNAIL probe set. See, e.g., U.S. Pat. Pub. 20190055594, which is hereby incorporated by reference in its entirety. In some instances, provided herein is a multiplexed proximity ligation assay. See, e.g., U.S. Pat. Pub. 20140194311 which is hereby incorporated by reference in its entirety. In some instances, provided herein is a probe or probe set capable of proximity ligation, for instance a proximity ligation assay for RNA (e.g., PLAYR) probe set. See, e.g., U.S. Pat. Pub. 20160108458, which is hereby incorporated by reference in its entirety. In some instances, a circular probe can be indirectly hybridized to the target nucleic acid. In some instances, the circular construct is formed from a probe set capable of proximity ligation, for instance a proximity ligation in situ hybridization (PLISH) probe set. See, e.g., U.S. Pat. Pub. 2020/0224243 which is hereby incorporated by reference in its entirety.

In some instances, the ligation involves chemical ligation. In some instances, the ligation involves template dependent ligation. In some instances, the ligation involves template independent ligation. In some instances, the ligation involves enzymatic ligation.

In some instances, the enzymatic ligation involves use of a ligase. In some aspects, the ligase used herein comprises an enzyme that is commonly used to join polynucleotides together or to join the ends of a single polynucleotide. An RNA ligase, a DNA ligase, or another variety of ligase can be used to ligate two nucleotide sequences together. Ligases comprise ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases comprise bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some instances, the ligase is a T4 RNA ligase. In some instances, the ligase is a splintR ligase. In some instances, the ligase is a single stranded DNA ligase. In some instances, the ligase is a T4 DNA ligase. In some instances, the ligase is a ligase that has an DNA-splinted DNA ligase activity. In some instances, the ligase is a ligase that has an RNA-splinted DNA ligase activity.

In some instances, the ligation herein is a direct ligation. In some instances, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some instances, said ends are not ligated directly to each other, but instead occurs either via the intermediacy of one or more intervening (so-called “gap” or “gap-filling” (oligo) nucleotides) or by the extension of 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo) nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific implementations, the gap may be a gap of about 1, 2, 3, 4, 5, 6, 7, 8, 9 or 10 or more nucleotides, of any integer (or range of integers) of nucleotides in between the indicated values. In some instances, the gap between said terminal regions may be filled by a gap oligonucleotide or by extending the 3′ end of a polynucleotide. In some cases, ligation involves ligating the ends of the probe to at least one gap (oligo) nucleotide, such that the gap (oligo) nucleotide becomes incorporated into the resulting polynucleotide. In some instances, the ligation herein is preceded by gap filling. In other implementations, the ligation herein does not require gap filling.

In some instances, ligation of the polynucleotides produces polynucleotides with melting temperature higher than that of un-ligated polynucleotides. Thus, in some aspects, ligation stabilizes the hybridization complex containing the ligated polynucleotides prior to subsequent steps, comprising amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some instances, the ligation herein is a proximity ligation of ligating two (or more) nucleic acid sequences that are in proximity with each other, e.g., through enzymatic means (e.g., a ligase). In some instances, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification:

In some instances, the hybridization of a primary probe or probe set (e.g. a circularizable probe or probe set) to a target analyte and may lead to the generation of an extension or amplification product. In some instances, a product is a primer extension product of an analyte, a labelling agent, a probe or probe set bound to the analyte (e.g., a circularizable probe bound to genomic DNA, mRNA, or cDNA), or a probe or probe set bound to the labelling agent (e.g., a circularizable probe bound to one or more reporter oligonucleotides from the same or different labelling agents.

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some instances, a product of an endogenous analyte and/or a labelling agent is an amplification product of one or more polynucleotides, for instance, a circular probe or circularizable probe or probe set. In some instances, the disclosed methods may comprise the use of a rolling circle amplification (RCA) technique to amplify signal. Rolling circle amplification is an isothermal, DNA polymerase-mediated process in which long single-stranded DNA molecules are synthesized on a short circular single-stranded DNA template using a single DNA primer (Zhao, et al. (2008). “Rolling Circle Amplification: Applications in Nanotechnology and Biodetection with Functional Nucleic Acids”. Angew Chem Int Ed Engl. 47 (34): 6330-6337; Ali, et al. (2014). “Rolling Circle Amplification: A Versatile Tool for Chemical Biology. Materials Science and Medicine”. Chem Soc Rev. 43 (10): 3324-3341). The RCA product is a concatemer containing tens to hundreds of tandem repeats that are complementary to the circular template, and may be used to develop sensitive techniques for the detection of a variety of targets, including nucleic acids (DNA, RNA), small molecules, proteins, and cells (Ali, et al. (2014), ibid.). In some implementations, a primer that hybridizes to the circular probe or circularized probe is added and used as such for amplification. In some instances, the RCA comprises a linear RCA, a branched RCA, a dendritic RCA, or any combination thereof.

In some instances, the amplification is performed at a temperature between or between about 20° C. and about 60° C. In some instances, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some instances, upon addition of a DNA polymerase in the presence of appropriate dNTP precursors and other cofactors, a primer is elongated to produce multiple copies of the circular template. This amplification step can utilize isothermal amplification or non-isothermal amplification. In some instances, after the formation of the hybridization complex and association of the amplification probe, the hybridization complex is rolling-circle amplified to generate a cDNA nanoball (i.e., amplicon) containing multiple copies of the cDNA. Techniques for rolling circle amplification (RCA) are known in the art such as linear RCA, a branched RCA, a dendritic RCA, or any combination thereof. (See, e.g., Baner et al, Nucleic Acids Research, 26:5073-5078, 1998; Lizardi et al, Nature Genetics 19:226, 1998; Mohsen et al., Acc Chem Res. 2016 Nov. 15; 49 (11): 2540-2550; Schweitzer et al. Proc. Natl Acad. Sci. USA 97:101 13-1 19, 2000; Faruqi et al, BMC Genomics 2:4, 2000; Nallur et al, Nucl. Acids Res. 29: e1 18, 2001; Dean et al. Genome Res. 1 1:1095-1099, 2001; Schweitzer et al, Nature Biotech. 20:359-365, 2002; U.S. Pat. Nos. 6,054,274, 6,291,187, 6,323,009, 6,344,329 and 6,368,801). Exemplary polymerases for use in RCA comprise DNA polymerase such phi29 (φ29) polymerase. Klenow fragment. Bacillus stearothermophilus DNA polymerase (BST), T4 DNA polymerase, T7 DNA polymerase, or DNA polymerase I. In some aspects, DNA polymerases that have been engineered or mutated to have desirable characteristics can be employed. In some instances, the polymerase is phi29 DNA polymerase.

In some aspects, during the amplification step, modified nucleotides can be added to the reaction to incorporate the modified nucleotides in the amplification product (e.g., nanoball). Exemplary of the modified nucleotides comprise amine-modified nucleotides. In some aspects of the methods, for example, for anchoring or cross-linking of the generated amplification product (e.g., nanoball) to a scaffold, to cellular structures and/or to other amplification products (e.g., other nanoballs). In some aspects, the amplification products comprises a modified nucleotide, such as an amine-modified nucleotide. In some instances, the amine-modified nucleotide comprises an acrylic acid N-hydroxysuccinimide moiety modification. Examples of other amine-modified nucleotides comprise, but are not limited to, a 5-Aminoallyl-dUTP moiety modification, a 5-Propargylamino-dCTP moiety modification, a N6-6-Aminohexyl-dATP moiety modification, or a 7-Deaza-7-Propargylamino-dATP moiety modification.

In some instances, the RCA template may comprise the target analyte, or a part thereof, where the target analyte is a nucleic acid, or it may be provided or generated as a proxy, or a marker, for the analyte. In some instances, the RCA template may comprise a sequence of the probes and probe sets hybridized to an endogenous analyte and/or a labelling agent. In some instances, the amplification product can be generated as a proxy, or a marker, for the analyte. As noted above, many assays are known for the detection of numerous different analytes, which use a RCA-based detection system, e.g., where the signal is provided by generating a RCP from a circular RCA template which is provided or generated in the assay, and the RCP is detected to detect the analyte. The RCP may thus be regarded as a reporter which is detected to detect the target analyte. However, the RCA template may also be regarded as a reporter for the target analyte; the RCP is generated based on the RCA template, and comprises complementary copies of the RCA template. The RCA template determines the signal which is detected, and is thus indicative of the target analyte. As will be described in more detail below, the RCA template may be a probe, or a part or component of a probe, or may be generated from a probe, or it may be a component of a detection assay (i.e. a reagent in a detection assay), which is used as a reporter for the assay, or a part of a reporter, or signal-generation system. The RCA template used to generate the RCP may thus be a circular (e.g. circularized) reporter nucleic acid molecule, namely from any RCA-based detection assay which uses or generates a circular nucleic acid molecule as a reporter for the assay. Since the RCA template generates the RCP reporter, it may be viewed as part of the reporter system for the assay.

In some instances, an assay may detect a product herein that includes a molecule or a complex generated in a series of reactions, e.g., hybridization, ligation, extension, replication, transcription/reverse transcription, and/or amplification (e.g., rolling circle amplification), in any suitable combination. For example, a product comprising a target sequence for a probe disclosed herein (e.g., a bridge probe or L-probe) may be a hybridization complex formed of a cellular nucleic acid in a sample and an exogenously added nucleic acid probe. The exogenously added nucleic acid probe may comprise an overhang that does not hybridize to the cellular nucleic acid but hybridizes to another probe (e.g., a detection probe). The exogenously added nucleic acid probe may be optionally ligated to a cellular nucleic acid molecule or another exogenous nucleic acid molecule. In other examples, a product comprising a target sequence for a probe disclosed herein (e.g., an anchor probe) may be an RCP of a circularizable probe or probe set which hybridizes to a cellular nucleic acid molecule (e.g., genomic DNA or mRNA) or product thereof (e.g., a transcript such as cDNA, a DNA-templated ligation product of two probes, or an RNA-templated ligation product of two probes). In other examples, a product comprising a target sequence for a probe disclosed herein (e.g., a bridge probe or L-probe) may be a probe hybridizing to an RCP. The probe may comprise an overhang that does not hybridize to the RCP but hybridizes to another probe (e.g., a detection probe).

### Signal Amplification Methods:

In some instances, a method disclosed herein may also comprise one or more signal amplification components and detecting such signals. In some instances, the present disclosure relates to the detection of nucleic acid sequences in situ using probe hybridization and generation of amplified signals associated with the probes. In some instances, the target nucleic acid of a nucleic acid probe comprises multiple target sequences for nucleic acid probe hybridization, such that the signal corresponding to a barcode sequence of the nucleic acid probe is amplified by the presence of multiple nucleic acid probes hybridized to the target nucleic acid. For example, multiple sequences can be selected from a target nucleic acid such as an mRNA, such that a group of nucleic acid probes (e.g., 20-50 nucleic acid probes) hybridize to the mRNA in a tiled fashion. In another example, the target nucleic acid can be an amplification product (e.g., an RCA product) comprising multiple copies of a target sequence (e.g., a barcode sequence of the RCA product).

Alternatively or additionally, amplification of a signal associated with a barcode sequence of a nucleic acid probe can be amplified using one or more signal amplification strategies off of an oligonucleotide probe that hybridizes to the barcode sequence. In some aspects, amplification of the signal associated with the oligonucleotide probe can reduce the number of nucleic acid probes needed to hybridize to the target nucleic acid to obtain a sufficient signal-to-noise ratio. For example, the number of nucleic acid probes to tile a target nucleic acid such as an mRNA can be reduced. In some aspects, reducing the number of nucleic acid probes tiling a target nucleic acid enables detection of shorter target nucleic acids, such as shorter mRNAs. In some instances, no more than one, two, three, 4, 5, 6, 7, 8, 9, 10, 11, 12, 13, 14, 15, 16, 17, 18, 19, or 20 nucleic acid probes may be hybridized to the target nucleic acid. In instances wherein the target nucleic acid is an amplification product, signal amplification off of the oligonucleotide probes may reduce the number of target sequences required for detection (e.g., the length of the RCA product can be reduced).

Exemplary signal amplification methods include targeted deposition of detectable reactive molecules around the site of probe hybridization, targeted assembly of branched structures (e.g., bDNA or branched assay using locked nucleic acid (LNA)), programmed in situ growth of concatemers by enzymatic rolling circle amplification (RCA) (e.g., as described in US 2019/0055594 incorporated herein by reference), hybridization chain reaction, assembly of topologically catenated DNA structures using serial rounds of chemical ligation (clampFISH), signal amplification via hairpin-mediated concatemerization (e.g., as described in US 2020/0362398 incorporated herein by reference), e.g., primer exchange reactions such as signal amplification by exchange reaction (SABER) or SABER with DNA-Exchange (Exchange-SABER). In some instances, a non-enzymatic signal amplification method may be used.

The detectable reactive molecules may comprise tyramide, such as used in tyramide signal amplification (TSA) or multiplexed catalyzed reporter deposition (CARD)-FISH. In some instances, the detectable reactive molecule may be releasable and/or cleavable from a detectable label such as a fluorophore. In some instances, a method disclosed herein comprises multiplexed analysis of a biological sample comprising consecutive cycles of probe hybridization, fluorescence imaging, and signal removal, where the signal removal comprises removing the fluorophore from a fluorophore-labeled reactive molecule (e.g., tyramide). Exemplary detectable reactive reagents and methods are described in U.S. Pat. No. 6,828,109, US 2019/0376956, WO 2019/236841, WO 2020/102094, WO 2020/163397, and WO 2021/067475, all of which are incorporated herein by reference in their entireties.

In some instances, hybridization chain reaction (HCR) can be used for signal amplification. HCR is an enzyme-free nucleic acid amplification based on a triggered chain of hybridization of nucleic acid molecules starting from HCR monomers, which hybridize to one another to form a nicked nucleic acid polymer. This polymer is the product of the HCR reaction which is ultimately detected in order to indicate the presence of the target analyte. HCR is described in detail in Dirks and Pierce, 2004, PNAS, 101(43), 15275-15278 and in U.S. Pat. Nos. 7,632,641 and 7,721,721 (see also US 2006/00234261; Chemeris et al, 2008 Doklady Biochemistry and Biophysics, 419, 53-55; Niu et al, 2010, 46, 3089-3091; Choi et al, 2010, Nat. Biotechnol. 28(11), 1208-1212; and Song et al, 2012, Analyst, 137, 1396-1401). HCR monomers typically comprise a hairpin, or other metastable nucleic acid structure. In the simplest form of HCR, two different types of stable hairpin monomer, referred to here as first and second HCR monomers, undergo a chain reaction of hybridization events to form a long nicked double-stranded DNA molecule when an “initiator” nucleic acid molecule is introduced. The HCR monomers have a hairpin structure comprising a double stranded stem region, a loop region connecting the two strands of the stem region, and a single stranded region at one end of the double stranded stem region. The single stranded region which is exposed (and which is thus available for hybridization to another molecule, e.g. initiator or other HCR monomer) when the monomers are in the hairpin structure may be known as the “toehold region” (or “input domain”). The first HCR monomers each further comprise a sequence which is complementary to a sequence in the exposed toehold region of the second HCR monomers. This sequence of complementarity in the first HCR monomers may be known as the “interacting region” (or “output domain”). Similarly, the second HCR monomers each comprise an interacting region (output domain), e.g. a sequence which is complementary to the exposed toehold region (input domain) of the first HCR monomers. In the absence of the HCR initiator, these interacting regions are protected by the secondary structure (e.g. they are not exposed), and thus the hairpin monomers are stable or kinetically trapped (also referred to as “metastable”), and remain as monomers (e.g. preventing the system from rapidly equilibrating), because the first and second sets of HCR monomers cannot hybridize to each other. However, once the initiator is introduced, it is able to hybridize to the exposed toehold region of a first HCR monomer, and invade it, causing it to open up. This exposes the interacting region of the first HCR monomer (e.g. the sequence of complementarity to the toehold region of the second HCR monomers), allowing it to hybridize to and invade a second HCR monomer at the toehold region. This hybridization and invasion in turn opens up the second HCR monomer, exposing its interacting region (which is complementary to the toehold region of the first HCR monomers), and allowing it to hybridize to and invade another first HCR monomer. The reaction continues in this manner until all of the HCR monomers are exhausted (e.g. all of the HCR monomers are incorporated into a polymeric chain). Ultimately, this chain reaction leads to the formation of a nicked chain of alternating units of the first and second monomer species. The presence of the HCR initiator is thus required in order to trigger the HCR reaction by hybridization to and invasion of a first HCR monomer. The first and second HCR monomers are designed to hybridize to one another are thus may be defined as cognate to one another. They are also cognate to a given HCR initiator sequence. HCR monomers which interact with one another (hybridize) may be described as a set of HCR monomers or an HCR monomer, or hairpin, system.

An HCR reaction could be carried out with more than two species or types of HCR monomers. For example, a system involving three HCR monomers could be used. In such a system, each first HCR monomer may comprise an interacting region which binds to the toehold region of a second HCR monomer; each second HCR may comprise an interacting region which binds to the toehold region of a third HCR monomer; and each third HCR monomer may comprise an interacting region which binds to the toehold region of a first HCR monomer. The HCR polymerization reaction would then proceed as described above, except that the resulting product would be a polymer having a repeating unit of first, second and third monomers consecutively. Corresponding systems with larger numbers of sets of HCR monomers could readily be conceived. Branching HCR systems have also been devised and described (see, e.g., WO 2020/123742 incorporated herein by reference), and may be used in the methods herein.

In some instances, similar to HCR reactions that use hairpin monomers, linear oligo hybridization chain reaction (LO-HCR) can also be used for signal amplification. In some instances, provided herein is a method of detecting an analyte in a sample comprising: (i) performing a linear oligo hybridization chain reaction (LO-HCR), wherein an initiator is contacted with a plurality of LO-HCR monomers of at least a first and a second species to generate a polymeric LO-HCR product hybridized to a target nucleic acid molecule, wherein the first species comprises a first hybridization region complementary to the initiator and a second hybridization region complementary to the second species, wherein the first species and the second species are linear, single-stranded nucleic acid molecules; wherein the initiator is provided in one or more parts, and hybridizes directly or indirectly to or is comprised in the target nucleic acid molecule; and (ii) detecting the polymeric product, thereby detecting the analyte. In some instances, the first species and/or the second species may not comprise a hairpin structure. In some instances, the plurality of LO-HCR monomers may not comprise a metastable secondary structure. In some instances, the LO-HCR polymer may not comprise a branched structure. In some instances, performing the linear oligo hybridization chain reaction comprises contacting the target nucleic acid molecule with the initiator to provide the initiator hybridized to the target nucleic acid molecule. In any of the instances herein, the target nucleic acid molecule and/or the analyte can be an RCA product.

In some instances, detection of nucleic acids sequences in situ includes combination of the sequential decoding methods described herein with an assembly for branched signal amplification. In some instances, the assembly complex comprises an amplifier hybridized directly or indirectly (via one or more oligonucleotides) to a sequence of an oligonucleotide probe described herein. In some instances, the assembly includes one or more amplifiers each including an amplifier repeating sequence. In some aspects, the one or more amplifiers is labeled. Described herein is a method of using the aforementioned assembly, including for example, using the assembly in multiplexed error-robust fluorescent in situ hybridization (MERFISH) applications, with branched DNA amplification for signal readout. In some instances, the amplifier repeating sequence is about 5-30 nucleotides, and is repeated N times in the amplifier. In some instances, the amplifier repeating sequence is about 20 nucleotides, and is repeated at least two times in the amplifier. In some aspects, the one or more amplifier repeating sequence is labeled. For exemplary branched signal amplification, see e.g., U.S. Pat. Pub. No. US20200399689A1 and Xia et al., Multiplexed Detection of RNA using MERFISH and branched DNA amplification. Scientific Reports (2019), each of which is fully incorporated by reference herein.

In some instances, an oligonucleotide probe described herein can be associated with an amplified signal by a method that comprises signal amplification by performing a primer exchange reaction (PER). In various instances, a primer with domain on its 3′ end binds to a catalytic hairpin, and is extended with a new domain by a strand displacing polymerase. For example, a primer with domain 1 on its 3′ ends binds to a catalytic hairpin, and is extended with a new domain 1 by a strand displacing polymerase, with repeated cycles generating a concatemer of repeated domain 1 sequences. In various instances, the strand displacing polymerase is Bst. In various instances, the catalytic hairpin includes a stopper which releases the strand displacing polymerase. In various instances, branch migration displaces the extended primer, which can then dissociate. In various instances, the primer undergoes repeated cycles to form a concatemer primer (see e.g., U.S. Pat. Pub. No. US20190106733, which is incorporated herein by reference, for exemplary molecules and PER reaction components).

### Barcoded Analytes and Detection:

A target sequence for a probe disclosed herein may be comprised in any analyte disclose herein, including an endogenous analyte (e.g., a viral or cellular nucleic acid), a labelling agent, or a product generated in the biological sample using an endogenous analyte and/or a labelling agent.

In some aspects, one or more of the target sequences includes or is associated with one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode comprises about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some instances, a barcode includes two or more sub-barcodes that together function as a single barcode. For example, a polynucleotide barcode can include two or more polynucleotide sequences (e.g., sub-barcodes) that are separated by one or more non-barcode sequences. In some instances, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In any of the preceding implementations, barcodes (e.g., primary and/or secondary barcode sequences) can be analyzed (e.g., detected or sequenced) using any suitable method or technique, including those described herein, such as sequencing by synthesis (SBS), sequencing by ligation (SBL), or sequencing by hybridization (SBH). In some instances, barcoding schemes and/or barcode detection schemes as described in RNA sequential probing of targets (RNA SPOTs), single-molecule fluorescent in situ hybridization (smFISH), multiplexed error-robust fluorescence in situ hybridization (MERFISH) or sequential fluorescence in situ hybridization (seqFISH+) can be used. In any of the preceding implementations, the methods provided herein can include analyzing the barcodes by sequential hybridization and detection with a plurality of labelled probes (e.g., detection probes (e.g., detection oligos) or barcode probes). In some instances, the barcode detection steps can be performed as described in hybridization-based in situ sequencing (HybISS). In some instances, probes can be detected and analyzed (e.g., detected or sequenced) as performed in fluorescent in situ sequencing (FISSEQ), or as performed in the detection steps of the spatially-resolved transcript amplicon readout mapping (STARmap) method. In some instances, signals associated with an analyte can be detected as performed in sequential fluorescent in situ hybridization (seqFISH).

In some instances, in a barcode-based detection method, barcode sequences are detected for identification of other molecules including nucleic acid molecules (DNA or RNA) longer than the barcode sequences themselves, as opposed to direct sequencing of the longer nucleic acid molecules. In some instances, a N-mer barcode sequence comprises 4N complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (4⁵=1024), whereas 8 nucleotide barcodes can be used to identify up to 65,536 molecular species, a number greater than the total number of distinct genes in the human genome. In some instances, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Sequential Hybridization:

In some instances, the present disclosure relates to methods and compositions for encoding and detecting analytes in a temporally sequential manner for in situ analysis of an analyte in a biological sample, e.g., a target nucleic acid in a cell in an intact tissue. In some aspects, provided herein is a method for detecting the detectably-labeled probes, thereby generating a signal signature. In some instances, the signal signature corresponds to an analyte of the plurality of analytes. In some instances, the methods described herein are based, in part, on the development of a multiplexed biological assay and readout, in which a sample is first contacted with a plurality of nucleic acid probes comprising one or more probe types (e.g., labelling agent, circularizable probe, circular probe, etc.), allowing the probes to directly or indirectly bind target analytes, which may then be optically detected (e.g., by detectably-labeled probes) in a temporally-sequential manner. In some instances, the probes or probe sets comprising various probe types may be applied to a sample simultaneously. In some instances, the probes or probe sets comprising various probe types may be applied to a sample sequentially. In some aspects, the method comprises sequential hybridization of labelled probes to create a spatiotemporal signal signature or code that identifies the analyte.

In some aspects, provided herein is a method involving a multiplexed biological assay and readout, in which a sample is first contacted with a plurality of nucleic acid probes, allowing the probes to directly or indirectly bind target analytes, which may then be optically detected (e.g., by detectably-labeled probes) in a temporally sequential manner. The plurality of nucleic acid probes themselves may be detectably-labeled and detected; in other words, the nucleic acid probes themselves serve as the detection probes. In other implementations, a nucleic acid probe itself is not directly detectably-labeled (e.g., the probe itself is not conjugated to a detectable label); rather, in addition to a target binding sequence (e.g., a sequence binding to a barcode sequence in an RCA product), the nucleic acid probe further comprises a sequence for detection which can be recognized by one or more detectably-labeled detection probes. In some instances, the probes or probe sets comprising various probe types may be applied to a sample simultaneously. In some instances, the probes or probe sets comprising various probe types may be applied to a sample sequentially. In some instances, the method comprises detecting a plurality of analytes in a sample.

In some instances, the method presented herein comprises contacting the sample with a plurality of probes comprising one or more probes having distinct labels and detecting signals from the plurality of probes in a temporally sequential manner, wherein said detection generates signal signatures each comprising a temporal order of signal or absence thereof, and the signal signatures correspond to said plurality of probes that identify the corresponding analytes. In some instances, the temporal order of the signals or absence thereof corresponding to the analytes can be unique for each different analyte of interest in the sample. In some instances, the plurality of probes hybridize to an endogenous molecule in the sample, such as a cellular nucleic acid molecule, e.g., genomic DNA, RNA (e.g., mRNA), or cDNA. In some instances, the plurality of probes hybridize to a product of an endogenous molecule in the sample (e.g., directly or indirectly via an intermediate probe). In some instances, the plurality of probes hybridize to labelling agent that binds directly or indirectly to an endogenous molecule in the sample or a product thereof. In some instances, the plurality of probes hybridize to a product (e.g., an RCA product) of a labelling agent that binds directly or indirectly to an endogenous molecule in the sample or a product thereof.

In any of the implementations disclosed herein, the detection of signals can be performed sequentially in cycles, one for each distinct label. In any of the implementations disclosed herein, signals or absence thereof from detectably-labeled probes targeting an analyte in a particular location in the sample can be recorded in a first cycle for detecting a first label, and signals or absence thereof from detectably-labeled probes targeting the analyte in the particular location can be recorded in a second cycle for detecting a second label distinct from the first label. In any of the implementations disclosed herein, a unique signal signature can be generated for each analyte of the plurality of analytes. In any of the implementations disclosed herein, one or more molecules comprising the same analyte or a portion thereof can be associated with the same signal signature.

In some instances, the in situ assays employ strategies for optically encoding the spatial location of target analytes (e.g., mRNAs) in a sample using sequential rounds of fluorescent hybridization. Microcopy may be used to analyze 4 or 5 fluorescent colors indicative of the spatial localization of a target, followed by various rounds of hybridization and stripping, in order to generate a large set of unique optical signal signatures assigned to different analytes. These methods often require a large number of hybridization rounds, and a large number of microscope lasers (e.g., detection channels) to detect a large number of fluorophores, resulting in a one to one mapping of the lasers to the fluorophores. Specifically, each detectably-labeled probe comprises one detectable moiety, e.g., a fluorophore.

In some aspects, provided herein is a method for analyzing a sample using a detectably-labeled set of probes. In some instances, the method comprises contacting the sample with a first plurality of detectably-labeled probes for targeting a plurality of analytes; performing a first detection round comprising detecting signals from the first plurality of detectably-labeled probes; contacting the sample with a second plurality of detectably-labeled probes for targeting the plurality of analytes; performing a second detection round of detecting signals from the second plurality of detectably-labeled probes, thereby generating a signal signature comprising a plurality of signals detected from the first detection round and second detection round, wherein the signal signature corresponds to an analyte of the plurality of analytes.

In some instances, detection of an optical signal signature comprises several rounds of detectably-labeled probe hybridization (e.g., contacting a sample with detectably-labeled probes), detectably-labeled probe detection, and detectably-labeled probe removal. In some instances, a sample is contacted with plurality first detectably-labeled probes, and said probes are hybridized to a plurality of nucleic acid analytes within the sample in decoding hybridization round 1. In some instances, a first detection round is performed following detectably-labeled probe hybridization. After hybridization and detection of a first plurality of detectably-labeled probes, probes are removed, and a sample may be contacted with a second plurality round of detectably-labeled probes targeting the analytes targeted in decoding hybridization round 1. The second plurality of detectably-labeled probes may hybridize to the same nucleic acid(s) as the first plurality of detectably-labeled probes (e.g., hybridize to an identical or hybridize to new nucleic acid sequence within the same nucleic acid), or the second plurality of detectably-labeled probes may hybridize to different nucleic acid(s) compared to the first plurality of detectably-labeled probes. Following m rounds of contacting a sample with a plurality of detectably-labeled probes, probe detection, and probe removal, ultimately a unique signal signature to each nucleic acid is produced that may be used to identify and quantify said nucleic acids and the corresponding analytes (e.g., if the nucleic acids themselves are not the analytes of interest and each is used as part of a labelling agent for one or more other analytes such as protein analytes and/or other nucleic acid analytes).

In some instances, after hybridization of a detectably-labeled probes (e.g., fluorescently labeled oligonucleotide) that detects a sequence (e.g., barcode sequence on a secondary probe or a primary probe), and optionally washing away the unbound molecules of the detectably-labeled probe, the sample is imaged and the detection oligonucleotide or detectable label is inactivated and/or removed. In some instances, removal of the signal associated with the hybridization between rounds can be performed by washing, heating, stripping, enzymatic digestion, photo-bleaching, displacement (e.g., displacement of detectably-labeled probes with another reagent or nucleic acid sequence), cleavage, quenching, chemical degradation, bleaching, oxidation, or any combinations thereof.

In some examples, removal of a probe (e.g., un-hybridizing the entire probe), signal modifications (e.g., quenching, masking, photo-bleaching, signal enhancement (e.g., via FRET), signal amplification, etc.), signal removal (e.g., cleaving off or permanently inactivating a detectable label) can be performed. Inactivation may be caused by removal of the detectable label (e.g., from the sample, or from the probe, etc.), and/or by chemically altering the detectable label in some fashion, e.g., by photobleaching the detectable label, bleaching or chemically altering the structure of the detectable label, e.g., by reduction, etc.). In some instances, the fluorescently labeled oligonucleotide and/or the intermediate probe hybridized to the fluorescently labeled oligonucleotide (e.g., bridge probe or L-probe) can be removed. In some instances, a fluorescent detectable label may be inactivated by chemical or optical techniques such as oxidation, photobleaching, chemically bleaching, stringent washing or enzymatic digestion or reaction by exposure to an enzyme, dissociating the detectable label from other components (e.g., a probe), chemical reaction of the detectable label (e.g., to a reactant able to alter the structure of the detectable label) or the like. For instance, bleaching may occur by exposure to oxygen, reducing agents, or the detectable label could be chemically cleaved from the nucleic acid probe and washed away via fluid flow.

In some instances, removal of a signal comprises displacement of probes with another reagent (e.g., probe) or nucleic acid sequence. For example, a given probe (e.g., detectably-labeled probes and/or the intermediate probe hybridized to the fluorescently labeled oligonucleotide (e.g., bridge probe or L-probe)) may be displaced by a subsequent probe that hybridizes to an overlapping region shared between the binding sites of the probes. In some cases, a displacement reaction can be very efficient, and thus allows for probes to be switched quickly between cycles, without the need for chemical stripping (or any of the damage to the sample that is associated therewith). In some instances, a sequence for hybridizing the subsequent or displacer probe (i.e. a toehold sequence) may be common across a plurality of probes capable of hybridizing to a given binding site. In some aspects, a single displacement probe can be used to simultaneously displace detection probes bound to an equivalent barcode position from all of the RCPs within a given sample simultaneously (with the displacement mediated by the subsequent detection probes). This may further increase efficiency and reduce the cost of the method, as fewer different probes are required.

After a signal is inactivated and/or removed, then the sample is re-hybridized in a subsequent round with a subsequent fluorescently labeled oligonucleotide, and the oligonucleotide can be labeled with the same color or a different color as the fluorescently labeled oligonucleotide of the previous cycle. In some instances, as the positions of the analytes, probes, and/or products thereof can be fixed (e.g., via fixing and/or crosslinking) in a sample, the fluorescent spot corresponding to an analyte, probe, or product thereof remains in place during multiple rounds of hybridization and can be aligned to read out a string of signals associated with each target analyte.

### Decoding:

A “decoding process” is a process comprising a plurality of decoding cycles in which different sets of barcode probes are contacted with target analytes (e.g., mRNA sequences) or target barcodes (e.g., barcodes associated with target analytes) present in a sample, and used to detect the target sequences or associated target barcodes, or segments thereof. In some instances, the decoding process comprises acquiring one or more images (e.g., fluorescence images) for each decoding cycle. Decoded barcode sequences are then inferred based on a set of physical signals (e.g., fluorescence signals) detected in each decoding cycle of a decoding process. In some instances, the set of physical signals (e.g., fluorescence signals) detected in a series of decoding cycles for a given target barcode (or target analyte sequence) may be considered a “signal signature” for the target barcode (or target analyte sequence). In some instances, a decoding process may comprise, e.g., 1, 2, 3, 4, 5, 6, 7, 8, 9, 10, or more than 10 decoding cycles. In some instances, each decoding cycle may comprise contacting a plurality of target sequences or target barcodes with 1, 2, 3, 4, 5, 6, 7, 8, 9, 10, or more than 10 barcode probes (e.g., fluorescently-labeled barcode probes) that are configured to hybridize or bind to specific target sequences or target barcodes, or segments thereof. In some instances, a decoding process may comprise performing a series of in situ barcode probe hybridization steps and acquiring images (e.g., fluorescence images) at each step. Systems and methods for performing multiplexed fluorescence in situ hybridization and imaging are described in, for example, WO 2021/127019 A1; U.S. Pat. No. 11,021,737; and PCT/EP2020/065090 (WO2020240025A1), each of which is incorporated herein by reference in its entirety.

### Anchor Probes:

In some instances, the present methods may further involve contacting the target analyte, e.g., a nucleic acid molecule, or proxy thereof with an anchor probe. In some instances, the anchor probe comprises a sequence complementary to an anchor probe binding region, which is present in all target nucleic acid molecules (e.g., in primary or secondary probes), and a detectable label. The detection of the anchor probe via the detectable label confirms the presence of the target nucleic acid molecule. The target nucleic acid molecule may be contacted with the anchor probe prior to, concurrently with, or after being contacted with the first set of detection probes. In some instances, the target nucleic acid molecule may be contacted with the anchor probe during multiple decoding cycles. In some instances, multiple different anchor probes comprising different sequences and/or different reporters may be used to confirm the presence of multiple different target nucleic acid molecules. The use of multiple anchor probes is particularly useful when detection of a large number of target nucleic acid molecules is required, as it allows for optical crowding to be reduced and thus for detected target nucleic acid molecules to be more clearly resolved.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Target molecules (e.g., nucleic acids, proteins, antibodies, etc.) can be detected in biological samples (e.g., one or more cells or a tissue sample) using an instrument having integrated optics and fluidics modules (an “opto-fluidic instrument” or “opto-fluidic system”). In an opto-fluidic instrument, the fluidics module is configured to deliver one or more reagents (e.g., fluorescent probes) to the biological sample and/or remove spent reagents therefrom. Additionally, the optics module is configured to illuminate the biological sample with light having one or more spectral emission curves (over a range of wavelengths) and subsequently capture one or more images of emitted light signals from the biological sample during one or more probing cycles. In various embodiments, the captured images may be processed in real time and/or at a later time to determine the presence of the one or more target molecules in the biological sample, as well as three-dimensional position information associated with each detected target molecule. Additionally, the opto-fluidics instrument includes a sample module configured to receive (and, optionally, secure) one or more biological samples. In some instances, the sample module includes an X-Y stage configured to move the biological sample along an X-Y plane (e.g., perpendicular to an objective lens of the optics module).

In various embodiments, the opto-fluidic instrument is configured to analyze one or more target molecules in their naturally occurring place (i.e., in situ) within the biological sample. For example, an opto-fluidic instrument may be an in-situ analysis system used to analyze a biological sample and detect target molecules including but not limited to DNA, RNA, proteins, antibodies, and/or the like.

A sample disclosed herein can be or be derived from any biological sample. Biological samples may be obtained from any suitable source using any of a variety of techniques including, but not limited to, biopsy, surgery, and laser capture microscopy (LCM), and generally includes cells, tissues, and/or other biological material from the subject. A biological sample can be obtained from a prokaryote such as a bacterium, an archaea, a virus, or a viroid. A biological sample can also be obtained from non-mammalian organisms (e.g., a plant, an insect, an arachnid, a nematode, a fungus, or an amphibian). A biological sample can also be obtained from a eukaryote, such as a tissue sample from a mammal. A biological sample from an organism may comprise one or more other organisms or components therefrom. For example, a mammalian tissue section may comprise a prion, a viroid, a virus, a bacterium, a fungus, or components from other organisms, in addition to mammalian cells and non-cellular tissue components. Subjects from which biological samples can be obtained can be healthy or asymptomatic subjects, subjects that have or are suspected of having a disease (e.g., an individual with a disease such as cancer) or a pre-disposition to a disease, and/or subjects in need of therapy or suspected of needing therapy.

The biological sample can include any number of macromolecules, for example, cellular macromolecules and organelles (e.g., mitochondria and nuclei). The biological sample can be obtained as a tissue sample, such as a tissue section, biopsy, a core biopsy, needle aspirate, or fine needle aspirate. The sample can be a fluid sample, such as a blood sample, urine sample, or saliva sample. The sample can be a skin sample, a colon sample, a cheek swab, a histology sample, a histopathology sample, a plasma or serum sample, a tumor sample, living cells, cultured cells, a clinical sample such as, for example, whole blood or blood-derived products, blood cells, or cultured tissues or cells, including cell suspensions.

In some embodiments, the biological sample may comprise cells or a tissue sample which are deposited on a substrate. As described herein, a substrate can be any support that is insoluble in aqueous liquid and allows for positioning of biological samples, analytes, features, and/or reagents on the support. In some embodiments, a biological sample is attached to a substrate. In some embodiments, the substrate is optically transparent to facilitate analysis on the opto-fluidic instruments disclosed herein. For example, in some instances, the substrate is a glass substrate (e.g., a microscopy slide, cover slip, or other glass substrate). Attachment of the biological sample can be irreversible or reversible, depending upon the nature of the sample and subsequent steps in the analytical method. In certain embodiments, the sample can be attached to the substrate reversibly by applying a suitable polymer coating to the substrate and contacting the sample to the polymer coating. The sample can then be detached from the substrate, e.g., using an organic solvent that at least partially dissolves the polymer coating. Hydrogels are examples of polymers that are suitable for this purpose. In some embodiments, the substrate can be coated or functionalized with one or more substances to facilitate attachment of the sample to the substrate. Suitable substances that can be used to coat or functionalize the substrate include, but are not limited to, lectins, poly-lysine, antibodies, and polysaccharides.

### Optical Subsystem for In Situ Analysis:

An instrument suitable for performing in situ analysis, for example in situ sequencing (e.g., using next generation sequencing techniques) of target analytes within a three-dimensional sample includes an optical subsystem that is capable of imaging optical signals (e.g., fluorescent emissions) from the target analytes (e.g., biological molecules such as DNA, RNA, proteins, etc.) in one or more color channels. For example, the optical signals may be fluorescent emissions from one or more nucleotides tagged with a fluorescent dye of a particular color (e.g., red, yellow, green, blue, nUV, etc.) for multicolor volumetric imaging. In various embodiments, the fluorescent dyes also include a reversible terminator that block further nucleotide addition until the terminator is removed (e.g., via cleavage). In various embodiments, the three-dimensional sample is a tissue sample (e.g., fresh frozen sample or FFPE). In various embodiments, the tissue sample has been optically cleared for epifluorescent imaging and permeabilized to allow for reagents to contact the target analytes therein. In various embodiments, the three-dimensional sample is a hydrogel having a plurality of analytes disposed (e.g., deposited) therein.

Because in situ analysis, such as in situ sequencing is intended to interrogate the naturally occurring positions of target analytes within the three-dimensional sample (and three-dimensional spatial density of the target analytes may not be known), the optical subsystem is configured for high spatial resolution imaging of target analytes in X, Y, and Z axes. In various embodiments, the optical subsystem for high-resolution in situ analysis such as in situ sequencing, particularly adapted for three-dimensional samples such as tissue sections or 3D hydrogels containing target analytes, includes at least one objective lens, which may be an infinity-corrected objective lens. In embodiments where an infinity-corrected objective lens is used, the optical subsystem includes at least one tube lens configured to receive parallel rays from the infinity-corrected objective lens and focus the rays to a focal point, where an image sensor (e.g., a CMOS sensor) is positioned. In various embodiments, the optical subsystem is configured for epifluorescence microscopy (where excitation light provided to the sample in the excitation channel is filtered out from any emission light provided to the image sensor in the emission channel). An infinity-corrected objective lens may be particularly suited for epifluorescence microscopy because the parallel rays in the infinity space (i.e., the space between the objective and the tube lens in which rays from the objective travel in a parallel, collimated beam to the tube lens) allow for the insertion of additional optical components, such as beamsplitters and filters, without introducing significant optical aberrations. To achieve the high resolution necessary for imaging individual, small clusters, or amorphous/diffuse regions of target analytes, the objective lens ideally possesses a high numerical aperture (NA). For example, objectives with NAs greater than or equal to 0.9, and more preferably, greater than or equal to 1.0, are contemplated to maximize resolution and light collection efficiency from fluorescently tagged analytes. In various embodiments, to achieve a higher NA, an objective capable of immersion in a liquid having a higher refractive index than air (e.g., water with a refractive index of about 1.33 or oil with a refractive index of about 1.51) is needed. Examples of such objective lenses include water immersion objectives (e.g., for NAs as high as ˜1.27) or oil immersion (e.g., for NAs as high as ˜1.4). However, it is understood that objectives with lower NAs may also be utilized depending on the specific resolution requirements and/or sample characteristics. For example, the NA of the objective lens may be at least 0.6, at least 0.7, at least 0.8, at least 0.9, at least 1.0, at least 1.1, at least 1.2, at least 1.3, from 0.6 to 1.4, from 0.7 to 1.4, from 0.8 to 1.4, from 0.9 to 1.4, from 1.0 to 1.4, from 0.9 to 1.1, about 0.9, about 1.0, about 1.1, about 1.2, about 1.3, or about 1.4. In various embodiments, the tube lens is selected to further optimize the imaging performance, ensuring that the combined optical system delivers sharp, high-contrast images of the target analytes throughout the field of view (FOV) in all imaging color channels (e.g., red, yellow, green, blue, nUV). In various embodiments, the objective lens includes a large FOV to maximize the image volume of a single z-stack of images (thereby reducing the number of z-stacks required to image an entire sample). For example, the FOV may have a diagonal of at least 0.50 mm, at least 0.75 mm, at least 0.80 mm, at least 0.90 mm, at least 1.00 mm, at least 1.10 mm, at least 1.20 mm, at least 1.30 mm, at least 1.40 mm, at least 1.50 mm, at least 1.60 mm, at least 1.70 mm, at least 1.80 mm, at least 1.90 mm, at least 2.00 mm, at least 2.25 mm, at least 2.50 mm, at least 2.75 mm, at least 3.00 mm, from 0.50 mm to 5.00 mm, from 0.75 to 4.00 mm, from 0.75 mm to 3.00 mm, from 0.75 mm to 2.00 mm, from 1.00 mm to 4.00 mm, from 1.00 mm to 3.00 mm, from 1.00 mm to 2.00 mm, about 1.00 mm, about 1.25 mm, about 1.5 mm, about 1.75 mm, about 2.00 mm, about 2.5 mm, or about 3.00 mm.

In various embodiments, the optical subsystem is designed to facilitate multicolor volumetric (e.g., z-stack) imaging at a plurality of FOVs of the sample, enabling the capture of high-resolution volumetric data from the sample in a plurality of color channels. In various embodiments, the instrument and/or optical subsystem is designed such that z-repeatability of relative z-motion of the objective lens and sample is less than the depth of focus of the objective lens. In various embodiments, the objective lens moves in Z and the stage is stationary. In various embodiments, the objective lens is stationary and the stage moves in Z. In various embodiments, both the objective lens and the stage have Z-motion capability. In various embodiments, the optical subsystem is designed such that the wavefront error, chromatic shift, and/or field curvature is less than the depth of focus of the objective lens and/or less than the step size between z-slices in the z-stack. In various embodiments, the z-step size is about 0.25 μm to about 2.00 μm, about 0.50 μm to about 1.50 μm, about 0.50 μm to about 1.00 μm, about 1.00 μm, about 0.90 μm, about 0.80 μm, about 0.75 μm, about 0.70 μm, about 0.60 μm, about 0.50 μm, or about 0.25 μm.

In various embodiments, the optical subsystem is designed to minimize various optical aberrations to maximize image quality across the entire z-stack of images. Specifically, the objective lens and tube lens are designed such that wavefront error, chromatic shift, and field curvature are very small. In various embodiments, the objective lens is designed such that substantially all of the illuminated FOV (which may be a smaller area than the full area of the circular FOV) is usable for decoding target analytes. In various embodiments, wavefront error, chromatic shift, and field curvature are significantly less than the depth of focus of the objective lens. By designing an optical subsystem with minimal wavefront aberration, light collected from the sample is accurately focused, preserving spatial resolution. Moreover, designing an optical subsystem with minimal chromatic shift is particularly useful for multi-color fluorescence imaging as misregistration of the different color channels is reduced (e.g., minimized). Lastly, designing an optical subsystem with corrected (minimal) field curvature ensures that the entire field of view remains in focus across each z-plane, allowing for greater spatial resolution in the Z-axis and potentially increasing the effective imaging area and throughput. In various embodiments, tight control of optical aberration(s) contributes to consistent and high image quality throughout the entire acquired z-stack in multicolor volumetric imaging, ultimately resulting in higher quality and reliable decoding and spatial localization of target analytes.

In various embodiments, the optical subsystem is designed for high-throughput imaging, allowing for rapid in situ sequencing analysis workflows, e.g. in situ sequencing workflows. In various embodiments, this optimization is achieved through several design considerations. Firstly, the optical subsystem is configured to image fluorescent dyes that require shorter exposure times to emit strong optical signals, thereby minimizing photobleaching and maximizing imaging speed. Secondly, the optical subsystem provides a large FOV, enabling the imaging of larger areas of the sample and reducing the number of z-stack acquisitions required to cover a given sample volume. Thirdly, the subsystem is engineered for rapid z-stack imaging, allowing for quick stepping between discrete z-slices in each z-stack. In various embodiments, quick z-stepping can be achieved through the integration of fast axial scanning mechanisms, which may integrate voice coil actuators, piezoelectric actuators, or other actuators to enable precise and rapid adjustment of the focal plane as well as high precision, high speed linear XY or XYZ stages (belt, screw, or electromagnetic driven), and tight feedback control loops and/or vibration control, which may integrate proportional control, proportional-integral control, or proportional-integral-derivative control, for precise and rapid switching between z-slices and/or FOVs.

It is to be noted that, although the above discussion relates to an opto-fluidic instrument that can be used for in situ target molecule detection via probe hybridization, the discussion herein equally applies to any opto-fluidic instrument that employs any imaging or target molecule detection technique. That is, for example, an opto-fluidic instrument may include a fluidics module that includes fluids needed for establishing the experimental conditions required for the probing of target molecules in the sample. Further, such an opto-fluidic instrument may also include a sample module configured to receive the sample, and an optics module including an imaging system for illuminating (e.g., exciting one or more fluorescent probes within the sample) and/or imaging light signals received from the probed sample. The in-situ analysis system may also include other ancillary modules configured to facilitate the operation of the opto-fluidic instrument, such as, but not limited to, cooling systems, motion calibration systems, etc.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. An imaging system, comprising:
a tube lens;
a first image sensor;
a second image sensor;
an objective disposed to direct emission light from a focal plane of the objective to the tube lens,
wherein the first image sensor and the second image sensor are arranged at focal planes of the tube lens; and
a beamsplitter disposed along a first optical axis between the tube lens and the first image sensor to intercept the path of the emission light, wherein the beamsplitter comprises:
an ingress face arranged perpendicular to the first optical axis,
a transmission-reflection face arranged oblique to the ingress face and downstream of the ingress face along the first optical axis, wherein the transmission-reflection face is arranged to transmit a first component of the emission light along the first optical axis and reflect a second component of the emission light along a second optical axis,
a first egress face arranged downstream of the transmission-reflectance face along the first optical axis, and
a second egress face arranged downstream of the transmission reflectance face along the second optical axis,
wherein the first egress face is arranged perpendicular to the first optical axis, and/or
the second egress face is arranged perpendicular to the second optical axis.

2. The imaging system of claim 1, wherein the first egress face is parallel to the ingress face.

3. The imaging system of claim 1, wherein the angle between the second egress face and the ingress face is equal to 180 degrees minus double the angle between the ingress face and the transmission-reflectance face, optionally wherein the transmission-reflection face is angled at 45 degrees with respect to the ingress face.

4. The imaging system of claim 1, wherein the beamsplitter is a dichroic beamsplitter, optionally wherein the transmission-reflection face is a dichroic face.

5. The imaging system of claim 1, wherein the beamsplitter includes a wavelength independent beamsplitting element and a colour filter associated with each of the first and second egress faces, optionally wherein the beamsplitting element is a 50-50 beamsplitter.

6. The imaging system of claim 1, wherein the beamsplitter has a rectangular prism shape, optionally a cube shape.

7. The imaging system of claim 1, wherein the beamsplitter comprises two triangular prisms, optionally wherein a face of one of the triangular prisms is mated to a face of the other and the transmission-reflection face comprises one or both of the mated faces.

8. The imaging system of claim 1, wherein the tube lens is a single tube lens.

9. The imaging system of claim 1, wherein the ingress face and first egress face are arranged so that astigmatism at the first image sensor is less than 0.075 RMS waves of the first component of emission light, and/or
wherein the ingress face and the second egress face are arranged so that astigmatism at the first image sensor is less than 0.075 RMS waves of the first component of emission light.

10. The imaging system of claim 1, wherein the ingress face and first egress face are arranged so that an optical path difference in the beamsplitter between marginal tangential rays and marginal sagittal rays equidistant from the first optical axis is less than about 1 wavelength of the first component, and/or
wherein the ingress face and second egress face are arranged so that an optical path difference in the beamsplitter between marginal tangential rays and marginal sagittal rays equidistant from the second optical axis is less than about 1 wavelength of the second component.

11. The imaging system of claim 1, wherein the objective comprises a numerical aperture (NA) of: at least 0.8, about 0.8 to about 1.2, or about 1.0.

12. The imaging system of claim 1, wherein the objective has a field of view (FOV) of about 1.1 mm measured across a diagonal, and/or
wherein field curvature is within a 0.35 mm depth of field for each colour channel, and/or
wherein an axial chromatic shift through the beamsplitter is less than about 0.1 mm, and/or
wherein a lateral chromatic shift across the beamsplitter is within 4.0 μm.

13. The imaging system of claim 1, wherein the ingress face is sized and positioned so that all rays of the emission light enter the beamsplitter through the ingress face.

14. The imaging system of claim 1, wherein the transmission-reflection face is a first transmission-reflection face and the beamsplitter further comprises:
a second transmission-reflection face arranged oblique to the ingress face and downstream of the ingress face along the first optical axis, wherein the second transmission-reflection face is arranged to transmit the first component of the emission light and reflect a third component of the emission light along a third optical axis, and
a third egress face arranged downstream of the second transmission-reflection face along the third optical axis,
wherein the third egress face is arranged perpendicular to the third optical axis.

15. The imaging system of claim 14, wherein the second transmission-reflection face intersects the first transmission-reflection face.

16. The imaging system of claim 1, further comprising a sample, wherein, when first and second fluorophores of the sample are excited by illumination light, the first and second components of the emission light are emitted by the first and second fluorophores respectively.

17. An imaging system, comprising:
a tube lens;
a first image sensor;
a second image sensor;
an objective disposed to direct emission light from a focal plane of the objective to the tube lens,
wherein the first image sensor and the second image sensor are arranged at focal planes of the tube lens; and
a beamsplitter disposed in an optical path between the tube lens and the first and second image sensor, wherein the beamsplitter comprises:
a first transmission channel arranged to transmit a first component of the emission light to the first image sensor, and
a second transmission channel arranged to transmit a second component of the emission light to the second image sensor,
wherein the first transmission channel is arranged so that astigmatism in the emission light at the first image sensor is less than 0.075 RMS waves of the first component of emission light, and/or
wherein the second transmission channel is arranged so that astigmatism in the emission light at the second image sensor is less than 0.075 RMS waves of the second component of emission light.

18. The imaging system of claim 17, wherein the first transmission channel is arranged so that an optical path difference in the beamsplitter between marginal tangential rays and marginal sagittal rays equidistant from an optical axis of the first transmission channel is less than about 1 wavelength of the first component, and/or
the second transmission channel is arranged so that an optical path difference in the beamsplitter between marginal tangential rays and marginal sagittal rays equidistant from an optical axis of the second transmission channel is less than about 1 wavelength of the second component.

19. A method for imaging a sample with the imaging system according to claim 1, the method comprising:
capturing, by the first image sensor and the second image sensor, images of emission light emitted by a sample at the focal plane of the objective,
wherein an image captured by the first image sensor corresponds to the first component of the emission light and an image captured by the second image sensor corresponds to the second component of the emission light.

20. The method of claim 19, the method further comprising:
prior to capturing the images of emission light, illuminating the sample with illumination light; and/or
generating, by at least one processor, combined image data by combining the images captured by the first image sensor and the second image sensor.
